(19) United States
(12) Patent Application Publication
(10) Pub. No.: US 2018/0031720 A1
(43) Pub. Date: Feb. 1, 2018

(54) Method and System for Generating a Subsurface Model

(71) Applicants: Tiago Etiene Queiroz, San Francisco, CA (US); Carlos A. Dietrich, New York, NY (US); Xiao-Hui Wu, Sugar Land, TX (US); Larisa V. Branets, Conroe, TX (US); Dar-Lon Chang, Sugar Land, TX (US); Matthias Imhof, Katy, TX (US)

(72) Inventors: Tiago Etiene Queiroz, San Francisco, CA (US); Carlos A. Dietrich, New York, NY (US); Xiao-Hui Wu, Sugar Land, TX (US); Larisa V. Branets, Conroe, TX (US); Dar-Lon Chang, Sugar Land, TX (US); Matthias Imhof, Katy, TX (US)

(21) Appl. No.: 15/659,476

(22) Filed: Jul. 25, 2017

Related U.S. Application Data
(60) Provisional application No. 62/368,598, filed on Jul. 29, 2016.

(51) Int. Cl. G01V 1/48; G06T 17/05; G06T 15/08

(52) U.S. Cl. CPC G01V 1/48; G06T 15/08; G06T 17/05; G01V 2210/66

(57) ABSTRACT

A method and system are described for creating a subsurface model. The method involves forming a volumetric representation having objects associated with the subsurface region; computing a value for each of the blocks based on an object priority function; and removing one or more blocks based on constraints and the object priority function to create the watertight model. Then, using the watertight model to perform simulations and in performing hydrocarbon operations.

### CROSS-REFERENCE TO RELATED APPLICATION

This application claims the benefit of U.S. Provisional Patent Application 62/368,598, filed Jul. 29, 2016, entitled METHOD AND SYSTEM FOR GENERATING A SUBSURFACE MODEL, the entirety of which is incorporated by reference herein.

### FIELD OF THE INVENTION

This disclosure relates generally to the field of hydrocarbon operations, such as exploration and production and, more particularly, to subsurface modeling. Specifically, the disclosure relates to a method for constructing subsurface models for a subsurface region and using the subsurface model for reservoir simulations. The simulation results and/or the subsurface model are used for hydrocarbon operations, such as hydrocarbon exploration, hydrocarbon development and/or hydrocarbon production.

### BACKGROUND

This section is intended to introduce various aspects of the art, which may be associated with exemplary embodiments of the present disclosure. This discussion is believed to assist in providing a framework to facilitate a better understanding of particular aspects of the present invention. Accordingly, it should be understood that this section should be read in this light, and not necessarily as admissions of prior art.

In exploration, development and/or production stages for resources, such as hydrocarbons, different types of subsurface models may be used to represent the subsurface structure, which may include a description of a subsurface structure and material properties for a subsurface region. For example, the subsurface model may be a watertight model, a geologic model or a reservoir model. The subsurface model may represent measured or interpreted data for the subsurface region, may be within a physical space or domain, and may include objects (e.g., horizons, faults, surfaces, volumes, and the like). The subsurface model may also be discretized with a mesh or a grid that includes nodes and forms blocks (e.g., cells, voxels or elements) within the model. By way of example, the watertight model may be created from a structural framework (e.g., organization of objects) and provide defined compartments or subvolumes. The geologic model may represent measured or interpreted data for the subsurface region, such as seismic data and/or well log data. The geologic model may be within a physical space or domain and may have material properties, such as rock properties. The reservoir model may be used to simulate flow of fluids within the subsurface region. Accordingly, the reservoir model may use the same grid and/or blocks as other models, or may resample or upscale the grid and/or blocks to lessen the computations for simulating the fluid flow.

The development of the reservoir model or geologic model may be problematic. For example, the process may include forming a grid from objects, such as horizons and faults. The resulting grid may not form closed compartments or subvolumes, which may be problematic for populating material properties into the objects and/or blocks. In particular, the objects may partially contact each other, thus, forming open areas or voids that are not closed compartments. Objects may also overlap. As a result, the material properties may have to be assigned manually (e.g., by a designer, modeler or user) to only one object or block at a time. In addition to being inefficient, the process may introduce errors and uncertainty through a manual process that is based on subjective decisions.

As an example, a meshed or gridded representation may include a large number of triangles to represent the subsurface region. In such a meshed representation, spurious assignments, holes and intersections may be a prevalent problem. If the meshes are created for the faults and horizons separately and then merged, the resulting mesh may include overlaps and gaps. Even one spurious intersection may be sufficient to render the mesh invalid for gridding, property assignment and simulation. Further, in repairing the mesh, conventional mesh repair approaches are based on different assumptions and designed for different topologies.

Conventional mesh repair approaches do not involve repairing certain types of object intersections, such as T-junctions, which involve multiple mesh elements intersecting along common edges. Indeed, conventional mesh repair algorithms are designed to eliminate T-junctions. Further still, conventional approaches require manual intervention to preserve T-junctions, while removing mesh overlaps and gaps.

Accordingly, there remains a need in the industry for methods and systems that are more efficient and may lessen problems associated with forming a subsurface model (e.g., a watertight model, a geologic model or a reservoir model) for use in hydrocarbon operations. Further, a need remains for efficient approaches to detect and repair mesh problems. The present techniques provide a method and apparatus that overcome one or more of the deficiencies discussed above.

### SUMMARY

In one embodiment, a method for generating a subsurface model having one or more object for a subsurface region is described. The method comprises: obtaining a volumetric representation associated with a subsurface region; obtaining a plurality of objects associated with the subsurface region, wherein the plurality of objects comprise one or more of faults, horizons, and any combination thereof; inserting the plurality of object into the volumetric representation, wherein the volumetric representation comprises a plurality of blocks; computing a value for each of the plurality of blocks based on an object priority function (e.g., signed distance or priority field); computing constraints; removing one or more blocks of the plurality of blocks based on the constraints and the object priority function to create the watertight model; and outputting the watertight model.

In another embodiment, a system for generating a subsurface model having one or more objects associated with a subsurface region is described. The computer system may include a processor; an input device in communication with the processor and configured to receive input data associated with a subsurface region; and memory in communication with the processor, the memory having a set of instructions. The set of instructions, when executed, are configured to: obtain a volumetric representation associated with a subsurface region; obtain a plurality of objects associated with the subsurface region, wherein the plurality of objects comprise one or more of faults, horizons, and any combination thereof; insert the plurality of object into the volumetric representation, wherein the volumetric representation comprises a plurality of blocks; compute a value for each of the plurality of blocks based on an object priority function (e.g., signed distance or priority field); compute constraints; remove one or more blocks of the plurality of blocks based on the constraints and the object priority function to create a watertight model; and output the watertight model.

### BRIEF DESCRIPTION OF THE DRAWINGS

The advantages of the present invention are better understood by referring to the following detailed description and the attached drawings.

FIG. 1 is an exemplary flow chart in accordance with an embodiment of the present techniques.

FIG. 2 is another exemplary flow chart in accordance with an embodiment of the present techniques.

FIGS. 3A and 3B are diagrams for creating a watertight model in accordance with an embodiment of the present techniques.

FIGS. 4A and 4B are alternative diagrams for creating a watertight model in accordance with an embodiment of the present techniques.

FIG. 5 is yet another alternative diagram for creating a watertight model in accordance with an embodiment of the present techniques.

FIG. 6 is an exemplary flow chart for repairing a mesh in accordance with an embodiment of the present techniques.

FIG. 7 is another exemplary flow chart for repairing a mesh in accordance with an embodiment of the present techniques.

FIG. 8 is yet another exemplary flow chart for repairing a mesh in accordance with an embodiment of the present techniques.

FIG. 9 is still another exemplary flow chart for repairing a mesh in accordance with an embodiment of the present techniques.

FIG. 10 is an exemplary flow chart for building a watertight model in accordance with an embodiment of the present techniques.

FIG. 11 is a block diagram of a computer system that may be used to perform any of the methods disclosed herein.

### DETAILED DESCRIPTION

In the following detailed description section, the specific embodiments of the present disclosure are described in connection with preferred embodiments. However, to the extent that the following description is specific to a particular embodiment or a particular use of the present disclosure, this is intended to be for exemplary purposes only and simply provides a description of the exemplary embodiments. Accordingly, the disclosure is not limited to the specific embodiments described below, but rather, it includes all alternatives, modifications, and equivalents falling within the true spirit and scope of the appended claims.

Various terms as used herein are defined below. To the extent a term used in a claim is not defined below, it should be given the broadest definition persons in the pertinent art have given that term as reflected in at least one printed publication or issued patent.

The articles “the”, “a” and “an” are not necessarily limited to mean only one, but rather are inclusive and open ended so as to include, optionally, multiple such elements.

As used herein, the term “hydrocarbons” are generally defined as molecules formed primarily of carbon and hydrogen atoms such as oil and natural gas. Hydrocarbons may also include other elements or compounds, such as, but not limited to, halogens, metallic elements, nitrogen, oxygen, sulfur, hydrogen sulfide (H₂S) and carbon dioxide (CO₂). Hydrocarbons may be produced from hydrocarbon reservoirs through wells penetrating a hydrocarbon containing formation. Hydrocarbons derived from a hydrocarbon reservoir may include, but are not limited to, petroleum, kerogen, bitumen, pyrobitumen, asphaltenes, tars, oils, natural gas, or combinations thereof. Hydrocarbons may be located within or adjacent to mineral matrices within the earth, termed reservoirs. Matrices may include, but are not limited to, sedimentary rock, sands, silicilytes, carbonates, diatomites, and other porous media.

As used herein, “hydrocarbon exploration” refers to any activity associated with determining the location of hydrocarbons in subsurface regions. Hydrocarbon exploration normally refers to any activity conducted to obtain measurements through acquisition of measured data associated with the subsurface formation and the associated modeling of the data to identify potential locations of hydrocarbon accumulations. Accordingly, hydrocarbon exploration includes acquiring measurement data, modeling of the measurement data to form subsurface models and determining the likely locations for hydrocarbon reservoirs within the subsurface. The measurement data may include seismic data, gravity data, magnetic data, electromagnetic data and the like.

As used herein, “hydrocarbon development” refers to any activity associated with planning of extraction and/or access to hydrocarbons in subsurface regions. Hydrocarbon development normally refers to any activity conducted to plan for access to and/or for production of hydrocarbons from the subsurface formation and the associated modeling of the data to identify preferred development approaches and methods. By way of example, hydrocarbon development may include modeling of the subsurface formation and extraction planning for periods of production; determining and planning equipment to be utilized and techniques to be utilized in extracting the hydrocarbons from the subsurface formation and the like.

As used herein, “hydrocarbon operation(s)” refers to any activity associated with hydrocarbon exploration, hydrocarbon development and/or hydrocarbon production.

As used herein, “hydrocarbon production” refers to any activity associated with extracting hydrocarbons from subsurface location, such as a well or other opening. Hydrocarbon production normally refers to any activity conducted to form the wellbore along with any activity in or on the well after the well is completed. Accordingly, hydrocarbon production or extraction includes not only primary hydrocarbon extraction, but also secondary and tertiary production techniques, such as injection of gas or liquid for increasing drive pressure, mobilizing the hydrocarbon or treating by, for example chemicals or hydraulic fracturing the wellbore to promote increased flow, well servicing, well logging, and other well and wellbore treatments.

As used herein, the term “framework” or “structural framework” means an organized assembly of objects (e.g., faults and/or horizons) within a specific volume known as an area or interest or volume of interest. The organization may include horizon order, truncation relationships and/or faulting order. The organized assembly of objects may include gaps between surfaces and/or voids within the specific volume.

As used herein, “watertight” means that a containing specific volume can be divided into one or more volume compartments with no overlapping volume compartments and with boundaries that have no holes. A watertight framework of faults and horizons divides a containing specified volume of interest into one or more volume compartments that have boundaries completely enclosing the compartments. Each fault and horizon is either a boundary of or contained within a volume compartment without any piece outside of a compartment. For example, in a watertight triangular mesh framework, every triangle face on the boundary of a compartment shares each of its edges with one other triangle to completely enclose the compartment. No two triangles may overlap partially. In some embodiments, no two triangles may overlap in their entirety. In another embodiment, this restriction is loosened only where two surfaces are merged. Contained within a volume compartment, there may be a partial fault that is not a boundary and does not completely subdivide the compartment, and a triangle face on the edge of the partial fault may not share an edge with another triangle.

As used herein, “triangle” refers to a polygon. Triangle may include quadrilateral or other polygons.

As used herein, “surface” refers to geologic features such as horizon and fault as well as technical features, such as model boundary, concession boundary, or artificial compartment boundary. A horizon separates two packages of rock. A fault is a discontinuity of rock packages. Often, a fault exhibits displacement. An artificial compartment boundary may be used for accounting purposes.

In hydrocarbon operations, a subsurface model is created in the physical space or domain to represent the subsurface region. The subsurface model is a computerized representation of a subsurface region based on geophysical and geological observations made on and below the surface of the Earth. The subsurface model may be a numerical equivalent of a three-dimensional geological map complemented by a description of physical quantities in the domain of interest. The subsurface model may include multiple dimensions and is delineated by objects, such as horizons and faults. The subsurface model may include a structural framework of objects, such as faults and horizons, and may include a mesh or grid of nodes to divide the structural framework and/or subsurface model into blocks, which may include cells in two dimensions, voxels in three dimensions or other suitable elements in other dimensions. A block, such as a cell or voxel, is a subvolume of the space, which may be constructed from nodes within the mesh. In the subsurface model, material properties, such as rock properties (e.g., permeability and/or porosity), may be represented as continuous volumes or unfaulted volumes in the design space, while the physical space may be represented as discontinuous volumes or faulted volumes (e.g., contain volume discontinuities, such as post-depositional faults).

Within the subsurface models, a grid or mesh may be used to partition the model into different subvolumes, which may be used in hydrocarbon operations, such as reservoir simulation studies in reservoir exploration, development and/or production stages, as well as for representing a subsurface model description of a reservoir structure and material properties. Accordingly, the grid or mesh may be configured to form blocks that may represent material properties, such as rock and fluid properties, of a reservoir or may be used for numerical discretization of partial differential equations, such as fluid flow or wave propagation.

The representation and updating of subsurface models involves complex computational challenges. Subsurface models may include objects, such as surfaces (e.g., faults or horizons) that intersect each other in arbitrary ways, which are often represented by pillar-based or triangle mesh-based data structures. Both representations, however, fail to offer a fast, intuitive approaches for the updating of the model geometry. The updating of the model geometry is usually necessary given the uncertainty on the model construction, and so there is still a need for a model representation that offer both an efficient data storage and support for updating operations.

As a result, the present techniques involve a parametric-based representation for subsurface models. The model surfaces are decomposed into smaller, manageable surface patches that are then converted into parametric patches. The parametric patches have no intersections other than their boundaries, so the conversion of a patch to a mesh (e.g., a triangle mesh) is manageable. In a preferred embodiment, the boundaries are in parametric formats governed by control points. In some embodiments, the shape of the patch is controlled by a small set of control points, which may facilitate change to the model topology without the burden of working directly on the geometry based representation. By working directly on control points, the updating of the model topology and geometry may be performed with high-level operations, without involving specific knowledge of the underlying data structure. Thus, the present techniques may be used to enhance subsurface models, which may be used for hydrocarbon operations and, more particularly, to subsurface modeling.

The present techniques describe a method and system for enhancing the generation of a subsurface model (e.g., watertight model, geologic model and/or reservoir model). Geologic models are often used to determine properties and structures of the subsurface region, while reservoir models are often used to determine hydrocarbon reserves in place and serve as inputs to reservoir simulation programs that predict the behavior of rocks and fluids contained therein under various scenarios of hydrocarbon recovery. Construction of a geologic model or a reservoir model is a multistep process. For a subsurface model, a structural framework is created from subsurface measurements. The structural framework may include various objects, such as faults, horizons, and if necessary, one or more surfaces that bound the area of interest. The different objects are meshed to define closed volumes (e.g., zones, compartments, or subvolumes). Then, the closed volumes are partitioned into small blocks defined by the grid. Finally, properties are assigned to objects (e.g., surface transmissibility) and individual blocks (e.g., rock type and/or porosity) in the watertight model to form the subsurface model. If the initial model is a geologic model, it may be upscaled to form a reservoir model.

To enhance the subsurface model building process, the present techniques provide enhancements to the creation and generation of subsurface models. A first enhancement is a process for forming a watertight model, which involves performing extrapolation, intersection and/or cleanup of objects in the structural framework. As the structural framework may include one or more horizons and/or one or more faults, gaps or voids as well as overlaps may be present between objects. Thus, the inputted objects may not have a quality acceptable enough to be discretized and uniquely intersected. For example, in some regions of the structural framework, objects may be interpreted or extended too far and may penetrate each other. In other regions, objects may fail to intersect each other and need to be extrapolated to contact other objects. The present techniques utilize a structural framework or discrete volumetric representation of the objects based on polygon complexes (e.g., cubic complexes). The discrete volumetric representation includes a volumetric grid of the subsurface region. From the volumetric grid, the present techniques removes or carves away blocks until the topology is not preserved. Accordingly, a priority field (e.g., an unsigned distance field) is computed or determined, which may be constrained by surfaces (e.g., fault and/or horizon), and may be used to control the carving order. The carving may also utilize an isosurface approach that assigns a signed-distance field to the objects (e.g., a surface of the object). The distance field may focus the carving to the objects and their respective extensions. Moreover, the volumetric representation may also be utilized to address pinchouts between faults, horizons or combinations thereof, which often cause problems because there may be multiple, isolated or folded intersections instead of a simple intersection. Accordingly, the volumetric representation may use the morphological image processing operators of erosion and dilation to simplify the intersections. Erosion removes the outermost blocks from an object. Dilation adds additional blocks next to existing ones. Closing is the performance of dilation, followed by the performance of erosion. Opening is the performance of erosion, followed by dilation. Morphological operators provide a mechanism to close gaps as well as to remove outliers or noise. For example, if the volumetric representation is based on cubic complexes, erosion is applied to create a hole in a horizon close to a noisy intersection with a fault, and dilation is applied to fill the hole smoothly and create a simpler intersection.

As a second enhancement, the present techniques provide mesh quality assessment and repair for a processed structural framework, which may be at least partially watertight. Mesh quality assessment and repair may also be used to improve the quality of the watertight framework. As part of the mesh quality assessment and repair, hierarchical smoothing is utilized to address problems with mesh repair. Hierarchical smoothing involves i) setting the order in which the surfaces are to be processed (e.g., based on truncation relationships defined by the watertight model); (ii) extracting the intersection among objects (e.g., intersection lines or contacts) as well as characteristic points of partial objects; and (iii) iteratively smoothing the objects. The smoothing of one object may set constraints for the smoothing of other objects when they share vertices along their intersections or contacts.

The mesh repair method provides interactive editing functionality for the watertight model. For example, the objects, such as surfaces, may be decomposed and converted into parametric patches that have no intersections other than their boundaries. This decomposition and conversion may facilitate the conversion of objects to polygon meshes (e.g., triangle or quadrangle meshes). The patch shape may be controlled by a small set of control points used to manipulate the watertight model. The watertight model may update or modify the topology and geometry with high-level operations on the control points without involving the knowledge of the underlying data structure.

In one or more embodiments, the present techniques may involve various steps to form the structural framework, the watertight model and resulting subsurface model. For example, the method may include computing of boundary surfaces to limit the model to the extent of the volume of interest. The computation of boundaries may include extracting boundaries and may be the output from the creation of the watertight model, which may be a set of objects (e.g., triangle or quadrangle meshes) and a set of volumes (e.g., compartments or groups of blocks). Further, the method may include computing volumes enclosed by objects. This computation may include recording the indices of the volumes or compartments in contact to each polygon mesh. Volume indices may be computed directly from a digital image or other suitable source. Then, the process may remove isolated faces or triangles. The isolated faces may be faces that are not adjacent to at least one volume. For example, polygons (e.g., triangles on the boundaries of faults, which may be above (below) the top (bottom) horizon, do not cope with such constraint, thus they may be detected and removed.

In addition, the method may include various steps to split or divide an object. For example, the method may include splitting surfaces based on adjacent volumes. In this method, an object may be split into smaller and manageable objects. The splitting process relies on volume indices to partition object in smaller objects, where each smaller object contains triangles adjacent to the same volume. Further, the method may include splitting surfaces based on faults. In this step, the faults may be re-meshed before being incorporated into the watertight model. Re-meshing faults may be performed when certain requirements as to fault's shape are satisfied, such as faults should not be shared by a non-convex surfaces. Accordingly, partial faults, horizons and boundary surfaces may be partitioned according to the fault network. A virtual extrusion of the fault is computed on the target surface, which splits the surface in two components. Also, the method may include splitting surface to remove holes or voids. Holes or voids may result from pinch-outs computations and/or from certain fault-fault intersections. As the voids may be problematic for re-meshing operations, the voids should be removed. As a result, objects or surfaces may be split in the voids, and each of the split objects may be re-meshing separately.

Moreover, the method may include some additional steps to re-orient objects, remove small objects, reassign small objects, and perform validation of the mesh. For example, the method may include re-orientating objects. For example, the polygon meshes may be oriented towards a specific direction or the outside of the model. As volumetric information is utilized to properly perform surface orientation, this operation may be performed during the conversion step, when the volumetric information is still available. The method may also include generating control points and reassigning or removing small objects from the model. The operation may be performed through a loop, which iteratively performs: (i) computing control points; (ii) computing contacts from the current control points; and (iii) removing invalid contacts. Further, the method may include validating the output mesh.

In one or more embodiments, the present techniques may involve various steps to repair the mesh. For example, once the watertight model is formed, the resulting meshes within the watertight model may still have certain geometric and topological deficiencies. These deficiencies may be a result of the parametric shape curves as well as distortions introduced during a parameterization process used in a re-meshing process to form the watertight framework. To remove these deficiencies, a method may be used that iteratively identifies inconsistencies and bad quality elements (e.g., nodes, edges and triangles) to produce a reliable output mesh. The repairing process performs on a local basis (e.g., on specific contacts of faults, horizons, or combination thereof) and on a global basis (e.g., on the watertight model) until no inconsistencies and/or bad quality elements are identified or until any repair may be applied without introducing additional damages to the mesh. In some embodiment, a tradeoff between different mesh quality measures is specified.

Further, various operations may be utilized to provide the enhancements to the watertight model in the mesh repair process. These operations may include edge splitting (e.g., by median length), removing one-manifold intersections, removing non-manifold vertexes, flipping cap triangles, flipping triangles with high dihedral angles, splitting cap triangles, removing small edges and splitting edges with boundary vertexes, or triangle merges. In some embodiments, these operations are performed on meshes based on quadrangles or sets of polygons may be used instead of triangles. Smoothing may be employed to the vertices of the mesh to enhance the mesh quality, which may be on a local basis (e.g., only over vertexes of intersecting polygons, such as triangles) and/or on a global (e.g., over all vertexes). The smoothing operation may also be utilized in the removal of polygon overlaps that are still be present in the watertight model after the one or more of the mesh repair operations are performed.

One of the mesh repair operations is edge splitting. The edge splitting operation may be utilized to obtain a mesh with an even distribution of polygon sizes. Accordingly, edges whose length is greater than a constant factor times the median edge length of whole mesh may be split, which is a global operation that may be performed on each of the edges within the watertight model. If the mesh configuration is triangular, each edge split operation gives rise to four triangles by connecting the created vertex to the two vertices of the triangles adjacent to the split edge that are not ends of the split edge. The edge splitting operation may be performed once the structural framework is formed into the watertight model and/or may be performed prior to other mesh repair operations.

Another of the mesh repair operation includes the removing one-manifold intersections operation. For the operation, boundary intersection between horizons and/or faults may result in 1-manifold structures, which are edges at the boundary of a fault that create a discontinuity in the horizon. At the lateral edge of a fault, throw tends to vanish. In some cases, the framework may exhibit artifacts such as finite throw or displacement at the edges of faults. A 1-manifold structure may need to be removed to avoid the creation of a throw in the boundary of a fault. The 1-manifold structures may be removed by collapsing the edges of the 1-manifold structure onto the corresponding fault and horizon.

Yet another of the mesh repair operations involves removing non-manifold vertexes. This operation may be used to simplify the mesh, which may involve removing unnecessary polygons. For example, the triangulation process can generate triangle patterns that are not relevant for the watertight model. Examples of such undesired patterns are triangles formed from three triangles. To remove the unnecessary triangles and simplify the mesh, the interior vertex and the adjacent triangles may be removed and replaced by one triangle.

The flipping cap triangle operation is another mesh repair operation. This operation may be used to manage cap triangles. For example, the triangularization process may generate cap triangles, which may generate invalid configurations between contacts and may not be properly handled by the tetrahedralization process. Accordingly, the flipping cap triangle operation may identify cap triangles and removed by flipping the edge opposite to the cap angle, resulting in a locally performed operation. A cap triangle may occur at a concavity of the contact. Four vertices may involve the formation of two different sets of triangles. Any adjustment may lead to the creation of a cap triangle that intersects other triangles. Flipping these triangles may remove the spurious intersection.

Also, the mesh repair operations may include flipping triangles with high dihedral angles operation. In this operation, small angled triangles may be modified to repair the mesh. For example, with certain triangulation, triangles may share an edge whose dihedral angle between them is below a threshold. These small angles may be a result of the re-meshing phase. When the small angled triangles are created, the quality of the final mesh is sub-optimal and may result in intersections of triangles in the same mesh and/or problems in the tetrahedralization phase. The flipping triangles with high dihedral angles operation involves flipping of the shared edge between the triangles being analyzed and generating two new triangles, which has a dihedral angle between them that is smaller than the previous version. The threshold may be a constraint set by a user or predefined as a set of instructions.

In addition, splitting cap triangle operation is yet another mesh repair operation. As noted above, cap triangles have a negative impact on the quality of the mesh and should be managed or removed. However, when the edge appositive from the cap angle is incident to another surface (e.g., fault, horizon or boundary surface), the flipping procedure should not be performed because other the resulting pair may intersect other triangles. In some embodiment, the cap triangle is split into two new triangles rather than flipped with one of its neighbors. This is performed by dividing the edge appositive to the cap angle into two new edges. The new vertex is connected to the cap angle vertex, resulting in two new triangles being created.

Yet another mesh repair operation involves the remove small edge operation. The small edge triangles may be generated from a re-meshing process. The length of an edge may be predefined within a set of instructions, as s user-defined constraint or other suitable parameter. As small edges in triangles may be removed without substantially degrading the geometric shape of the underlying surface, the triangles in the mesh may be reformed to remove the small edge of the triangle, which may facilitate the tetrahedralization process. The operation may have a predefined length of an edge, which may be predefined within a set of instructions, and/or may be a user-defined constraint. The operation may involve collapsing the two end vertices. The collapse is performed to avoid triangle folding, thus ensuring no inconsistency is introduced to the mesh.

Another mesh repair operation is the splitting edges with boundary vertices operation. Similar to the splitting cap triangle operation, this operations may divide edges that are not on the boundary of the corresponding surface, but containing a vertex on a boundary. For example, one vertex should be on the boundary, but a second vertex from the same triangle is also placed on this boundary. Splitting the edge allows moving the second vertex off the boundary.

In one or more embodiments, a method for generating a subsurface model having one or more object for a subsurface region is described. The method comprises: obtaining a volumetric representation associated with a subsurface region; obtaining a plurality of objects associated with the subsurface region, wherein the plurality of objects comprise one or more of faults, horizons, and any combination thereof; inserting the plurality of object into the volumetric representation, wherein the volumetric representation comprises a plurality of blocks; computing a value for each of the plurality of blocks based on an object priority function (e.g., signed distance or priority field); computing constraints; removing one or more blocks of the plurality of blocks based on the constraints and the object priority function to create the watertight model; and outputting the watertight model.

Further, the method may include other enhancements. For example, the method may include wherein the computing the value for each of the plurality of blocks comprises computing the value based on a priority field or based on a signed distance; computing one or more intersections of two or more of the plurality of object, and applying a morphological operator to the one or more intersections; wherein the watertight model comprises a watertight mesh that comprises a plurality of model blocks; creating a geologic model from the watertight model by assigning properties to one or more of the plurality of model blocks in the watertight model; creating a reservoir model from the watertight model by assigning properties associated with fluid flow to one or more of the plurality of blocks in the watertight model; simulating fluid flow within the reservoir model to create simulation results; managing hydrocarbon production based on the simulation results; and/or identifying blocks in the mesh of the watertight model that need repair, applying to the identified blocks one or more of a local re-meshing operation, an edge-flipping operation, a collapsing operation and any combination thereof, and outputting the updated watertight model. Further, the method may include wherein computing the constraints comprises: determining whether the object priority function value is a local minimum relative to specified adjacent blocks; determining a removed or missing neighboring block for each of the plurality of blocks; determining whether the block has a flag or indication; determining whether each of the plurality of blocks is enclosed by adjacent blocks; and flagging the block if it is enclosed by adjacent blocks; and/or determining whether the object priority function value is within a specified range.

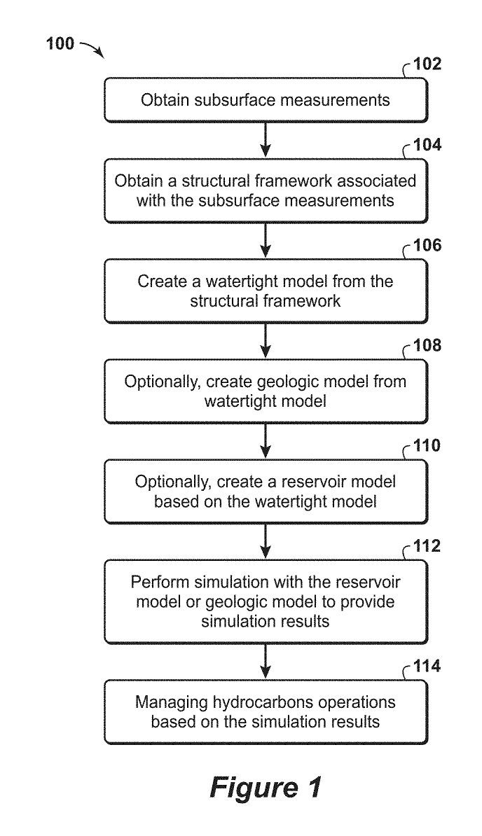

Beneficially, the present techniques provide various enhancements to the hydrocarbon extraction process. A framework may be generated with less effort, with less intervention and in a shorter time allowing the generation of a more realistic subsurface model, simulation and analysis of more complex models, and better quantification of risks and uncertainties. The present techniques may be further understood with reference to FIGS. 1 to 11, which are described further below.

FIG. 1 is an exemplary flow chart 100 in accordance with an embodiment of the present techniques. The flow chart 100 includes a method for creating a subsurface model from subsurface measurements. The method may include obtaining data and creating a watertight model from a structural framework for the subsurface region, as shown in blocks 102 to 106, modifying the watertight model to form one or more subsurface models, as shown in blocks 108 to 110, and using the subsurface model to perform simulations and for hydrocarbon operations, as shown in blocks 112 and 114.

The method begins by obtaining data and creating a watertight model, as shown in blocks 102 to 106. As shown in block 102, subsurface measurements are obtained. The obtaining of subsurface measurements may include accessing measurements from a database associated with the subsurface region and/or performing one or more acquisition surveys to obtain subsurface measurements for the subsurface region. The performing one or more acquisition surveys may include acquiring and/or processing seismic data, core samples, wireline data, gravitational data, magnetic data and/or electromagnetic data. Then, as shown in block 104, a structural framework associated with the subsurface measurements may be obtained. The obtaining of structural framework, which may be referred to as a volumetric representation, may include accessing a structural framework from a database, updating or modifying a structural framework with the subsurface measurements and/or creating a structural framework based on the subsurface measurement. The structural framework may include mesh elements, which may each include a block, such as a cell or a voxel, formed by the mesh and associated nodes. The mesh is a discretization of the objects and includes various nodes that may form mesh elements. For example, the mesh elements in a 3D grid may be a tetrahedron or hexahedron or a triangle or quadrilateral, and the geometrical classification may be the shape or type of the mesh element. A variety of known techniques exist for mesh generation in a volumetric domain (e.g., Delaunay tetrahedralization, or advancing front methods), which may be used in the present techniques. Accordingly, the present techniques may include finite-element grids, and/or even hybrid grids of several element types, such as prisms and tetrahedrals.

At block 106, a watertight model is created from the structural framework. The creation of the watertight model may include performing extrapolation, intersection and/or cleanup of objects in the structural framework. As noted above, the structural framework may include one or more horizons and/or one or more faults, which may have gaps or voids between objects. The creation of the watertight model may involve filling the gaps within the structural framework and then performing mesh repairs on the filled structural framework to create the watertight model. The filling the gaps within the structural framework may include generating a discrete volumetric representation of the objects within the structural framework based on polygon complexes (e.g., cubic complexes), which include a volumetric grid of the subsurface region. A discrete volumetric representation partitions the model into mutually exclusive blocks that span the entire volume of interest without gaps. Each surface can be mapped to a set of blocks. Furthermore, each surface can be mapped to a set of block faces. For hexahedral blocks, this constriction to block faces leads to cubic complexes, but the process applies to any kind of block. Then, blocks within the discrete volumetric representation may be removed based on constraints, such as maintaining the topology, and an object priority function (e.g., a priority field and/or an unsigned distance field). The filling of the structural framework may include using one or more morphological operators, such as erosion, dilation, opening and closing to address pitchouts within the volumetric representation. Erosion is the process of removing the outermost elements of an object. Dilation is the process of adding an additional element to the outermost elements of an object. Opening and closing are combinations of erosion and dilation. The performing the mesh repairs may include performing mesh quality assessment and repair for the filled structural framework, which may be a watertight model. The mesh quality assessment and repair may include hierarchical smoothing, which involves i) setting the order in which the surfaces are to be processed (e.g., based on truncation relationships defined by the watertight model); (ii) extracting the intersection among objects (e.g., intersection lines or contacts) as well as characteristic points of partial objects; and (iii) iteratively smoothing the objects. The mesh repair may provide interactive editing functionality for the watertight model, such as decomposing object and converting the objects into parametric patches that have no intersections other than their boundaries. The mesh repair may include performing operations, such as edge splitting (e.g., by median length), removing one-manifold intersections, removing non-manifold vertexes, flipping cap triangles, flipping triangles with high dihedral angles, splitting cap triangles, removing small edges and splitting edges with boundary vertexes.

Once the watertight model is created, the watertight model may be modified to create one or more subsurface models, as shown in blocks 108 to 110. At block 108, a geologic model may optionally be created from the watertight model. The creation of the geologic model may include populating the blocks and/or objects within the watertight model with properties. The geologic model, which represents a specific portion of the subsurface region, may include one or more objects (e.g., horizons, faults, volumes, and the like) and may have material properties associated with the various objects. The material properties may include one or more of surface transmissibility, permeability, rock type, facies, porosity, fluid saturation, pressure and any combination thereof. At block 110, the reservoir model may optionally be created based on the watertight model. The creation of the reservoir model may include creating the reservoir model directly from the watertight model or creating the reservoir model based on the geologic model, which is created from the watertight model. The creation of the reservoir model may include upscaling the underlying base model (e.g., the geologic model or watertight model) to provide a different scale for the reservoir model as compared with the underlying base model. Then, the creation of the reservoir model may include populating the blocks and/or objects within the model (e.g., the geologic model, watertight model, or upscaled model) with properties. The reservoir model, which represents a specific portion of the subsurface region, may include one or more objects (e.g., horizons, faults, volumes, and the like) and may have material properties associated with the various objects.

Once created, the subsurface model may be utilized to perform simulations and the model and associated results may be used for hydrocarbon operations, as shown in blocks 112 and 114. At block 112, a simulation is performed with the reservoir model and/or the geologic model to provide simulation results. The performing the simulation may include modeling fluid flow based on the reservoir model and the associated properties stored within the blocks of the reservoir model. The simulation results may include the computation of time-varying fluid pressure and fluid compositions (oil, water, and gas saturation) and the prediction of fluid volumes produced or injected at wells. The performing the simulation may include modeling structural changes based on the geologic model and the associated properties stored within the blocks of the geologic model. For example, reducing reservoir pressure may reduce porosity which may lead to a sagging overburden. The simulation results and/or the reservoir model may be outputted. The outputting of the simulation results and/or the subsurface model may include displaying the simulation results, the geologic model and/or the reservoir model on a monitor and/or storing the simulation results, the geologic model and/or the reservoir model in memory of a computer system. At block 114, the simulation results may be utilized to manage the hydrocarbons. The hydrocarbon operations may include hydrocarbon exploration operations, hydrocarbon development operations and/or hydrocarbon production operations. For example, the simulation results, the geologic model and/or the reservoir model may be used to estimate or adjust reserves forecasts, reserves estimations and/or well performance prediction. As another example, the simulation results, the geologic model and/or the reservoir model may be used to adjust hydrocarbon production operations, such as installing or modifying a well or completion, modifying or adjusting drilling operations, decreasing fracture penetration, and/or to installing or modifying a production facility. The production facility may include one or more units to process and manage the flow of production fluids, such as hydrocarbons and/or water, from the formation.

Beneficially, this method provides an enhancement in the production, development and/or exploration of hydrocarbons. In particular, the method may be utilized to enhance development of a watertight model by providing an enhanced model with less computational effort, less interactive intervention, and/or in a shorter time. As a result, this may provide enhancements to production at lower costs and lower risk.

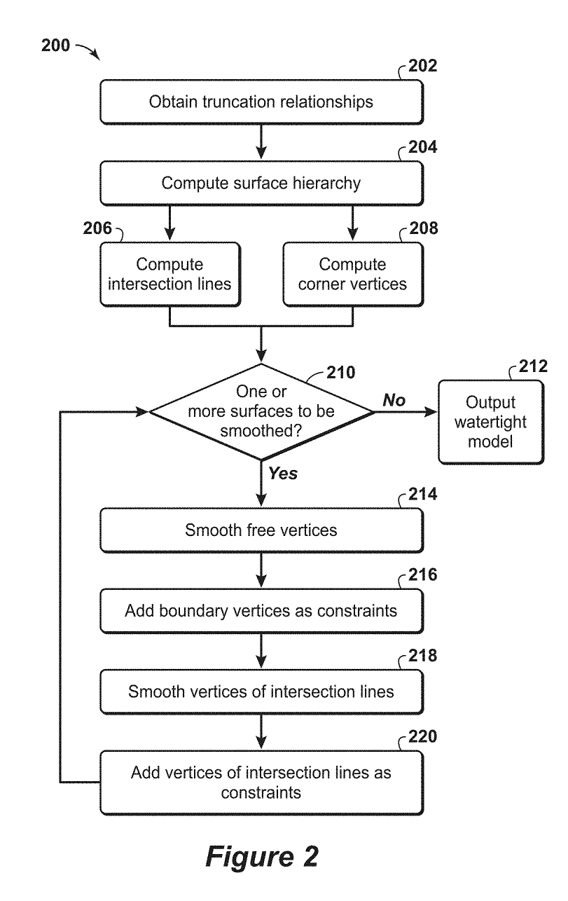

As an enhancement, the present techniques involve hierarchical smoothing. As an example, manifold triangle mesh smoothing (e.g., surfaces without T-junctions) is a conventional approach utilized for geometry processing applications. The smoothing removes high-frequency details from triangle meshes, which typically result from noise introduced during the mesh creation. Therefore, smoothing enhances the overall quality of the surface. Smoothing of non-manifold triangle meshes (e.g., surfaces with T-like junctions) is not typically managed by conventional approaches. Because non-manifold surfaces are ubiquitous in geologic applications, conventional approaches either do not handle these problems or require user intervention. The present techniques provide an automated process for handling the non-manifold surfaces. The method involves: i) setting the order in which the surfaces are to be processed, based on the truncation relationship defined by the user; ii) extracting the intersection among surfaces (e.g., intersection lines) and corner points of partial surfaces, if any; and iii) iteratively smoothing of each of the surfaces. The smoothing of one surface sets constraints for the smoothing of other surfaces when they share vertices along their intersections. As such, an appropriate order is set in which surfaces may be smoothed independently and still retain the shape of their intersections. An exemplary method for performing the hierarchical smoothing is provided in FIG. 2.

As an example, the hierarchical smoother may include various steps to update the model. The first step may obtain the truncation relationship defined among the input surfaces and compute a hierarchy, which is an order in which the surfaces are to be processed. The second step involves computing the intersection lines among the input surfaces, and also a set of corner vertices of partial surfaces (e.g., corners of surfaces that do not intersect other surfaces, which may be utilized as constraints to prevent the deformation of such surfaces). The corner vertices are the first constraints of the smoothing algorithm. Then, one surface at a time, the smoothing iteration starts from the top level surface in the list. For each surface, the iteration starts by smoothing the free (e.g., unconstrained) vertices, adds the boundary vertices as constraints, smooths the intersection lines and finally adds the intersection lines as constraints. The procedure is repeated until no surfaces are left.

FIG. 2 is another exemplary flow chart 200 in accordance with an embodiment of the present techniques. This is an exemplary method for creating a watertight model from a structural framework in block 106 of FIG. 1. The method involves determining intersection lines and constrained vertices of the structural framework, as shown in blocks 202 to 208, and then smoothing surfaces based on the intersecting lines and constrained vertices, as shown in blocks 210 to 220. The smoothing may be a hierarchical smoothing of non-manifold surfaces.

The method begins by determining intersections and constrained vertices, as shown in blocks 202 to 208. In block 202, truncation relationships are obtained. The truncation relationships may include the fault ordering (e.g., defining the faults as major and minor for an intersection) and/or horizon ordering. For example, if a major fault and a minor fault intersect, the major fault does not get cut off, while the minor fault is truncated. As another example, an older fault may be the minor fault and the newer fault may be the major fault. The resulting intersection may result in the older fault getting displaced, while the newer fault remains substantially continuous. As yet another example, if a major horizon and a minor horizon intersect, the major horizon (e.g., nonconformity) erodes or truncates the minor horizon. Then, in block 204, the surface hierarchy is computed. The surface hierarchy is computed by obtaining the truncation relationship defined among the input surfaces and computing a hierarchy, an order in which the surfaces are to be processed. The hierarchy may specified by the user or it may be estimated based on size, dip and other surface properties. The surface hierarchy may include a listing of surfaces and/or a priority setting for each of the surfaces. At block 206, intersection lines are computed. The computation of intersection lines may utilize the truncation relationships, surface hierarchy, inputted data, and the surfaces (e.g., the listing of surfaces). The output from this computation may include a listing of the intersection lines. At block 208, the corner vertices are computed. The computation of the corner vertices may use the surfaces (e.g., the listing of surfaces) and provide a listing of constrained vertices. The listing of constrained vertices may include a set of corner vertices of partial surfaces (e.g., corners of surfaces that do not intersect other surfaces), which may be set as constraints to prevent the deformation of such surfaces.

Once the listing of intersecting lines and the listing of constrained vertices are created, the smoothing of surfaces may be performed, as shown in blocks 210 to 220. In block 210, a determination is made whether one or more surfaces are to be smoothed. Determination may be based on mesh quality attributes, such as dihedral angles or mesh invalidity due to intersecting triangles and/or may be based on an instruction or indication from a user. If no surfaces are to be smoothed, the process may output the watertight model in block 212. However, if one or more surfaces are to be smoothed, the process may perform the smoothing operations in blocks 214 to 220. The smoothing operations may be performed on the surfaces, which may be in a specific order or based on a specific sequence, or based on notifications. The order may be specified by the user. The order may be determined from the surface hierarchy where surfaces placed lower in the hierarchy are smoothed more. Lastly, smoothing one surface may necessitate the smothering of another one. In some embodiment, a notification of sent from one surface to another one to request its smoothing. This process may involve starting with the corner vertices that are set as the first constraints of the smoothing algorithm or operation. For each identified surface, the smoothing operations may be performed with each surface individually. In block 214, the free vertices are smoothed. The smoothing of free vertices may be based on the constrained vertices, which may include user specified vertices, well-penetration points, or vertices selected by an algorithm, e.g., random sampling. Then, at block 216, the boundary vertices are added as constraints. The boundary vertices are pinned down and cannot be moved anymore. In one embodiment, the user inputs a list of vertices on the model boundary. In another embodiment, the area of interest is analyzed to determine the area of interest polygon and its vertices. Mesh vertices that lie on the vertical extension of the area of interest polygon vertices are used as smoothing constraints. In a preferred embodiment, the area of interest is specified by the vertices of a polygon and mesh vertices that lie on the vertical extension of the area of interest polygon vertices are used as smoothing constraints. At block 218, the vertices of the intersection lines are smoothed. The smoothing of the vertices of the intersection lines is performed by smoothing the parametric form of the intersection. In a preferred embodiment, the parametric form is spline. In another embodiment, the parametric form is a polynomial. At block 220, the vertices of the intersection lines are then added as constraints. The adding of the vertices of the intersection lines may include examining the distance between points and including additional points based on a distance threshold and/or based on curvature of the parametric form. The constrained vertices from the intersection lines and the boundaries may include vertices that involve multiple intersections and/or are identified by a user. Then, the process proceeds to block 210 to determinate whether one or more surfaces are to be smoothed. In no additional surfaces are to be smoothed, the process outputs the watertight model in block 212. The outputting of the watertight model may include storing the watertight model in memory and/or displaying the watertight model.

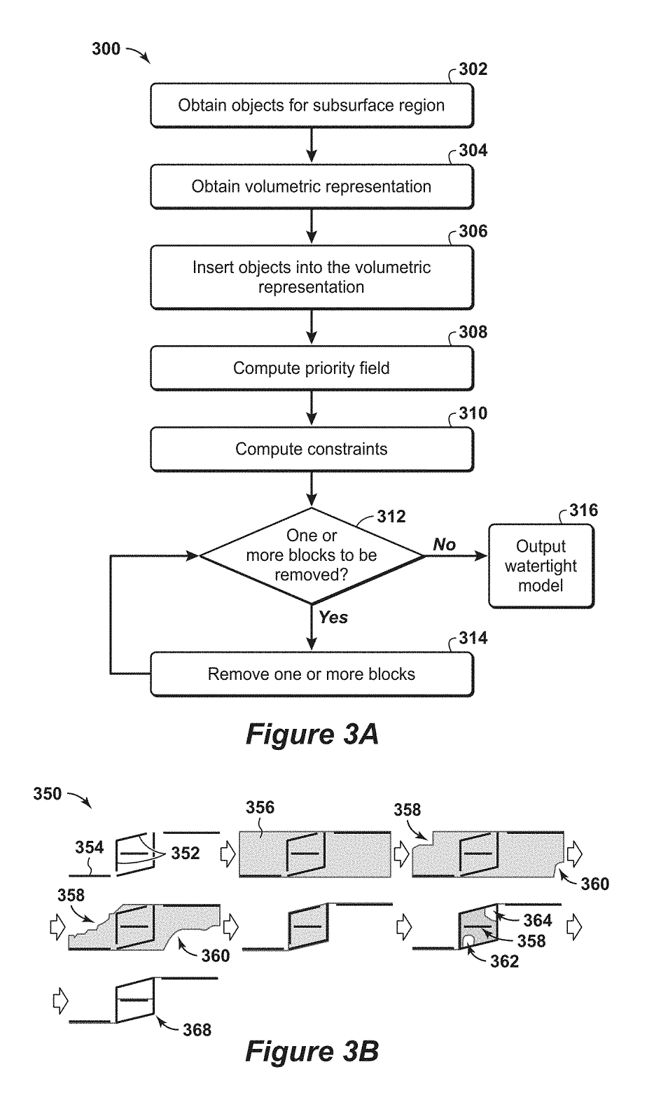

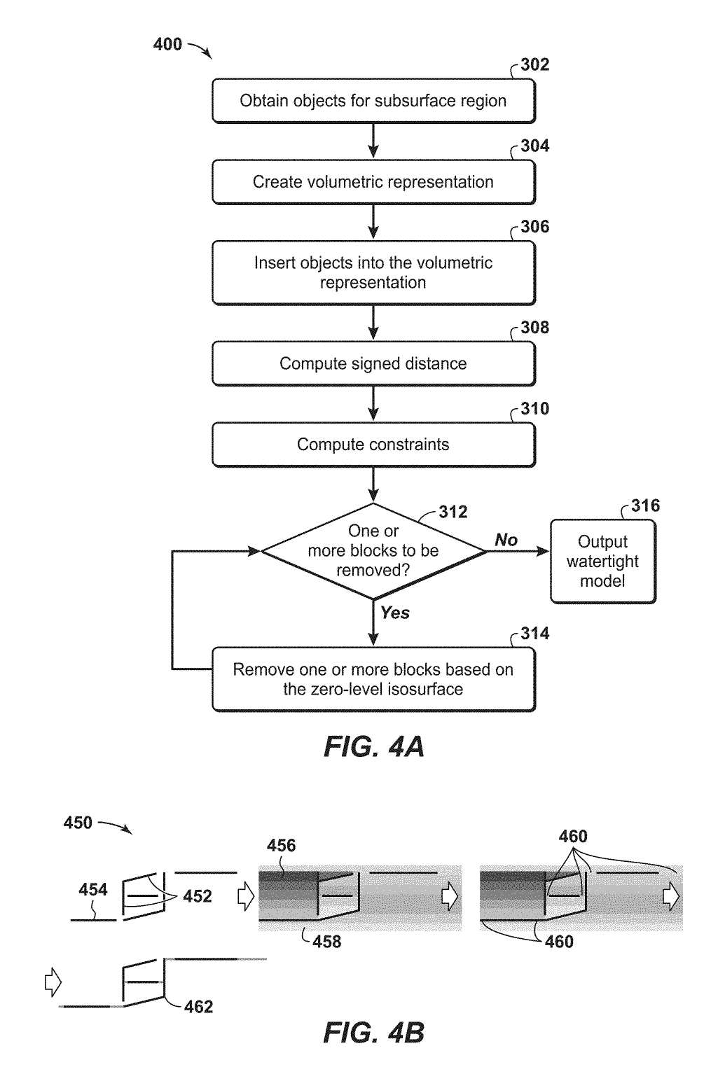

As may be appreciated, the subsurface model may be used in processes that utilize a watertight model as the input model (e.g., having fault and horizon surfaces) to be populated with properties. Conventional approaches for building watertight models are labor-intensive and limited in several ways. For example, the techniques may build a mesh for faults and a mesh for horizons, which are merged together into an improperly formed mesh. Accordingly, as an enhancement to building a watertight model, the present techniques include various processes to create watertight models, which include filling the gaps within the structural framework. One technique utilizes hierarchical carving procedure, which is described further in FIGS. 3A and 3B, while another technique utilizes isosurface extraction, which is described further in FIGS. 4A and 4B. Each of these techniques utilize a volumetric representation, which is a discrete representation of blocks. While various techniques may be used to build the volumetric representation, the volumetric representation may be built using cubic complexes where surfaces are discretized along the faces of the blocks. Then, one or more horizons and one or more faults may be inputted into the respective volumetric representation. Then, one or more object priority functions (e.g., signed distance or priority field) may be computed and utilized to remove blocks from the volume to form the watertight model.

The hierarchical carving techniques may start from a volumetric grid, and carve out blocks (e.g., cells or voxels) until the removal of blocks may change the model topology. A priority field (e.g., an unsigned distance field) may be utilized to manage the carving order. The distance field should be constrained by fault surfaces. For example, the method may include (i) converting objects (e.g., surfaces, such as faults and/or horizons) to a volumetric representation; (ii) defining a volume around objects (e.g., faults and horizons); (iii) define a carving order using a priority field; (iv) remove blocks while their removal does not change the topology of the underlying horizon. FIGS. 3A and 3B are examples of this technique.

FIGS. 3A and 3B are diagrams 300 and 350 for creating a watertight model in accordance with an embodiment of the present techniques. FIG. 3A is a flow diagram 300 for creating a watertight model in accordance with an embodiment of the present techniques. This is an exemplary method for creating a watertight model from a structural framework in block 106 of FIG. 1. The method involves inserting objects (e.g., set of faults, horizons and/or other surfaces) into the volumetric representation. Then, input objects are converted to a volumetric representation and used to compute a priority field, which may be defined as the shortest Manhattan distance to the object. The Manhattan distance is the number of block faces encountered when between a block of the inputted object and the specified target block. In another embodiment, Euclidian distance may be used for define the distance field. The distance field may start at an initial object (distance 0) and increases as the block moves away from the initial object. Then, the method removes blocks from the volume as long as the constraints do not change (e.g., the topology remains unchanged). The procedure may stop when no additional blocks can be removed subject to the constraints, which results in a new object that replaces the input object. By way of example, the method may include creating a volumetric representation, as shown in blocks 302 to 306, removing certain blocks until a watertight model is created, as shown in blocks 308 to 314, and outputting the watertight model, as shown in block 316. The method utilizes priority fields and constraints to determine the blocks that should be removed.

The process begins by creating a volumetric representation, as shown in blocks 302 to 306. In block 302, objects for a subsurface region are obtained. The objects may include one or more horizons, faults, other surfaces such as compartment boundaries, concession boundaries, or model boundaries, and any combination thereof. The obtaining of objects may include accessing one or more objects from a database, updating or modifying objects from subsurface measurements and/or creating objects based on the subsurface measurements. Then, a volumetric representation is obtained, as shown in block 304. The obtaining the volumetric representation may include creating the volumetric representation and/or accessing the volumetric representation from memory. At block 306, the objects are inserted into the volumetric representation. The insertion of the object may include labeling blocks of the volumetric representation by the one or multiple surfaces that pass through the block or splitting blocks that host multiple horizons or multiple faults. In some embodiment, if both a first and a second surface pass through a same block, then the second surface is moved to an adjacent block.

Once the objects are inserted into the volumetric representation, certain blocks may be removed until a watertight model is created, as shown in blocks 308 to 314. At block 308, a priority field is computed. The computing the priority field may include calculating the shortest distance, such as the shortest Manhattan distance and/or Euclidian distance, to the object. Then, the constraints are computed in block 310. The computation of the constraints may include determining minimum distance threshold, determining whether distance at the block is a local minimum (e.g., below a threshold), determining a removed or missing neighboring block, determining whether the block has a flag or indication that it is a conflicting block, determining whether the block is within an enclosed set of blocks to flag it as a potential block for removal and/or determining whether the distance is within a specified range. At block 312, a determination is made whether one or more blocks are to be removed. If one or more blocks are to be removed, the process may remove one or more blocks, as shown in block 314. Then, the process may include determine whether one or more additional blocks are to be removed in block 312. If no blocks are to be removed, the watertight model is outputted, as shown in block 316. The outputting of the watertight model may include storing the watertight model in memory and/or displaying the watertight model.

FIG. 3B is an exemplary diagram 350 of forming the watertight model using the method of FIG. 3A. In this diagram 350, the transition of the objects is shown along the arrows to the final formation of a watertight model 368. In the initial diagram, one or more objects are shown as faults, such as faults 352 and horizons, such as horizon 354. Then, a volumetric representation 356 is formed by embedding the objects in the blocked volume and portions of the volumetric representation are removed as shown by voids 358 and 360. These voids 358 and 360 continue to expand as more blocks are removed. At 360, no additional block can be removed without artificially removing at least one interior block. Then, additional voids 362 and 364 are formed for an interior region. Then, the resulting watertight model 368 is created once the removal process is complete.

Another technique utilizes isosurface extraction, which is described further in FIGS. 4A and 4B. This is an exemplary method for creating a watertight model from a structural framework in block 106 of FIG. 1. In this method, an isosurface-like approach is utilized to accelerate the carving procedure. An isosurface is an implicit surface that represents points of a constant value. The isosurface method builds a signed distance field for each horizon. In a preferred embodiment, the signed distance field is represented at the centers of each block. In another embodiment, the signed distance field is represented at the block vertices. In a preferred embodiment, the signed distance field is constrained by fault surfaces. Then, a surface in the watertight framework is specified by the set of block faces lying between positive and negative blocks or block vertices. By way of example, the method may use input data, such as a set of faults and the horizon, which are to be corrected. Then, the input objects are converted into a volumetric representation and used to compute a signed distance field. The signed distance field may start at an initial object and increase in the normal direction and decreases in the opposite direction. The method may remove select faces lying between positive and negative blocks. The result is a new object that replaces the input object.

FIG. 4A is an alternative diagram 400 for creating a watertight model in accordance with an embodiment of the present techniques. In this diagram 400, the method may include creating a volumetric representation, as shown in blocks 402 to 406, removing certain blocks until a watertight model is created, as shown in blocks 408 to 414, and outputting the watertight model, as shown in block 416. The method utilizes signed distance fields and constraints to determine the blocks that should be removed.

The process begins by creating a volumetric representation, as shown in blocks 402 to 406. In block 402, objects for a subsurface region are obtained. The objects may include one or more horizons, faults, technical boundaries such as compartment boundaries, concession boundaries, or model boundaries, and any combination thereof. The obtaining of objects may be performed in a similar manner to block 302 of FIG. 3. Then, a volumetric representation is obtained, as shown in block 404. The obtaining the volumetric representation may be performed in a similar manner to block 304 of FIG. 3. At block 406, the objects are inserted into the volumetric representation. The insertion of the object may be performed in a similar manner to block 306 of FIG. 3.

Once the objects are inserted into the volumetric representation, certain blocks may be removed until a watertight model is created, as shown in blocks 408 to 414. At block 408, a signed distance field is computed. The computing the signed distance field may include computing a distance from a specified object to a plurality of blocks. In a preferred embodiment, the distance is based on the Manhattan distance which can be computed by propagating the distance from one block to the next block. The first iteration determines the sign of the distance. In one embodiment, blocks that lie directly above a block containing the object are labelled positive one (+1), while blocks that lie directly below a block containing the object are labelled negative one (−1). In another embodiment, the definitions of positive and negative are reversed. Regardless, the magnitude is increased when propagating the distances while the sign is passed along. In places where the surface is inputted, it is marked by a distance of zero. In places where the surface is not inputted, its extension is marked by a sign change of the signed distance function. Then, the constraints are computed in block 410. The computation of the constraints may include determining minimum distance threshold, determining whether distance at the block is a local minimum (e.g., below a threshold), determining a removed or missing neighboring block, determining whether the block has a flag or indication that it is a conflicting block, determining whether the block is within an enclosed set of blocks to flag it as a potential block for removal and/or preferably determining whether the distance is within a specified range. The specified adjacent blocks are blocks that share a block face with the specified block. For example with a horizon, the adjacent specified blocks may include blocks that share a block face and are vertically stacked relative to the specified block. As another example for a fault, the adjacent specified blocks may include blocks that share a block face and are oriented laterally relative to the specified block. At block 412, a determination is made whether one or more blocks are to be removed. If one or more blocks are to be removed, the process may remove one or more blocks based on the zero-level isosurface, as shown in block 414. Then, the process may include determine whether one or more additional blocks are to be removed in block 412. If no additional blocks are to be removed, the watertight model is outputted, as shown in block 416. The outputting of the watertight model may include storing the watertight model in memory and/or displaying the watertight model.

FIG. 4B is an exemplary diagram 450 of forming the watertight model using the method of FIG. 4A. In this diagram 450, the transition of the objects is shown along the arrows to the final formation of a watertight model. In the initial diagram, one or more objects are shown as faults, such as faults 452 and horizons, such as horizon 454. Then, a volumetric representation is formed, which has a positive distance field 456 and a negative distance field 458. The signed distance fields 456 and 458 start from horizons, such as horizon 454 and going around faults 452. The signed distance fields 456 and 458 grow from the horizon and propagate into the volume, filling the gaps in the horizon. Then, the resulting signed distance fields 456 and 458 can be used to extract an isosurface using the volumetric representation. A vertical sign change indicates the location of the (extrapolated) horizon 454. The additional segments 460 are the additions to the objects at the interface of the signed distance fields 456 and 458 for the various objects. Then, the resulting watertight model 462 is created once the isosurface extraction is complete.

In addition, the present techniques include a method of managing pinchout computations for the creation of a watertight model is described. Computing horizon pinchouts directly from a mesh representation may be problematic. The intersection between two horizons can be non-uniform and its computation is typically not robust. Accordingly, the present techniques utilize a volumetric representation based on cubic complexes to compute pinchouts. By converting to a volumetric representation, morphologic operators may be used to compute the approximate region of the pinchout. The morphologic operations include opening and closing. Opening first performs at least one iteration of erosion, followed by at least one iteration of dilation. The erosion steps remove small regions where surfaces are separated. The subsequent dilation cannot restore removed regions simplifying the horizon-horizon boundary. Closing first performs at least one iteration of dilation, followed by at least one iteration of erosion. The dilation connects nearby regions. The subsequent erosion cannot remove the connection because this changes the topology. In a preferred embodiment, a user-specified number of closing operations are performed. In a preferred embodiment, a user-specified number of opening operations are performed. By way of example, when a first horizon intersects with a second horizon, the intersection may not be smooth, but may contains many voids or isolated blocks. By utilizing the pinchout computations of the present techniques, the present techniques may compute high-quality pinchouts to lessen the problems with intersections. By way of example, the pitchout computations may include obtaining a pair of horizons, which are inserted into a volumetric representation. Then, the intersection of the pair of horizons is computed, which approximately defines the pinchout region. Then, morphologic operators are utilized to repair the faulty intersection, which provides a well-defined pinchout region.

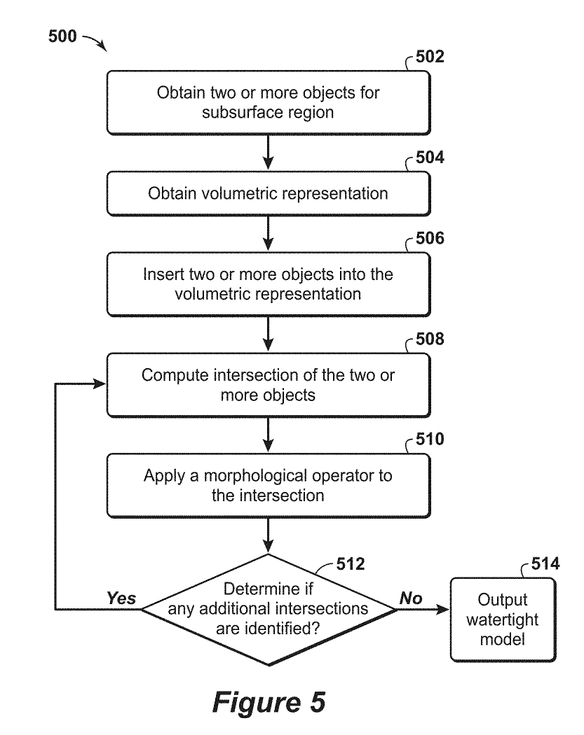

FIG. 5 is yet another alternative diagram for creating a watertight model in accordance with an embodiment of the present techniques. In this diagram 500, the method is utilized for pitchout computations. While this may be used for any intersection between surfaces, it may be the flow chart for morphological cleanup of pinchouts. The method may include creating a volumetric representation with two or more objects, as shown in blocks 502 to 506, determining the intersection of the objects and repairing the faulty pinchouts, as shown in blocks 508 to 514, and outputting the watertight model, as shown in block 516.

The process begins by creating a volumetric representation, as shown in blocks 502 to 506. In block 502, two or more objects for a subsurface region are obtained. The objects may include one or more horizons, faults, or technical boundary surfaces, such as model boundaries, block boundaries, or concession boundaries, and any combination thereof. The obtaining of objects may be performed in a similar manner to block 302 of FIG. 3. Then, a volumetric representation is obtained, as shown in block 504. The obtaining the volumetric representation may be performed in a similar manner to block 304 of FIG. 3. At block 506, the two or more objects are inserted into the volumetric representation. The insertion of the two or more objects may be performed in a similar manner to block 306 of FIG. 3.

Once the objects are inserted into the volumetric representation, intersections between objects may be identified and repaired until a watertight model is created, as shown in blocks 508 to 514. At block 508, intersections are computed for the two or more objects. The computing the intersections may include intersecting the cubic complexes. Then, a morphological operator may be applied to the intersection in block 510. The applying the morphological operator may include opening operator and closing operator. At block 512, a determination is made whether one or more intersections are identified. If one or more intersections are identified, the process may compute the intersection of the objects in block 508 and then apply the morphological operator in block 510. If no additional intersections are identified, the watertight model is outputted, as shown in block 514. The outputting of the watertight model may include storing the watertight model in memory and/or displaying the watertight model.

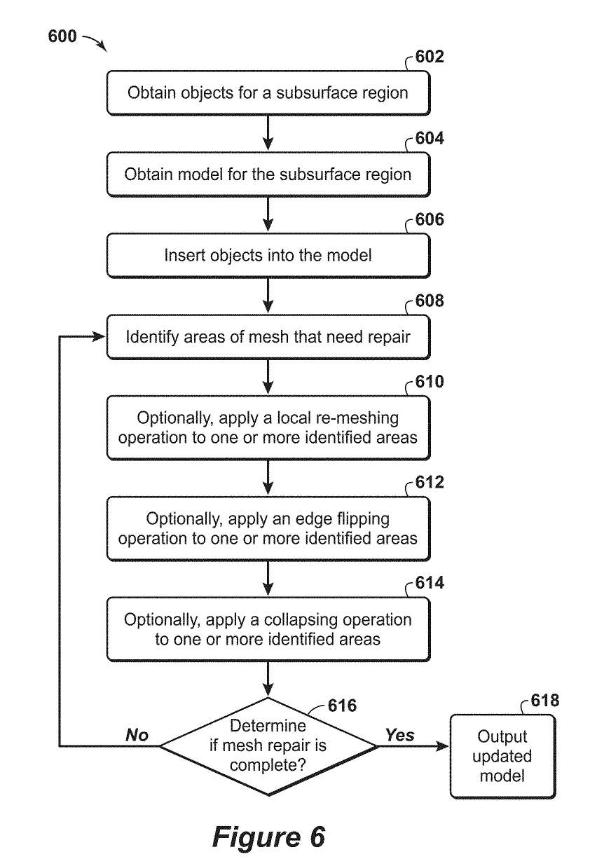

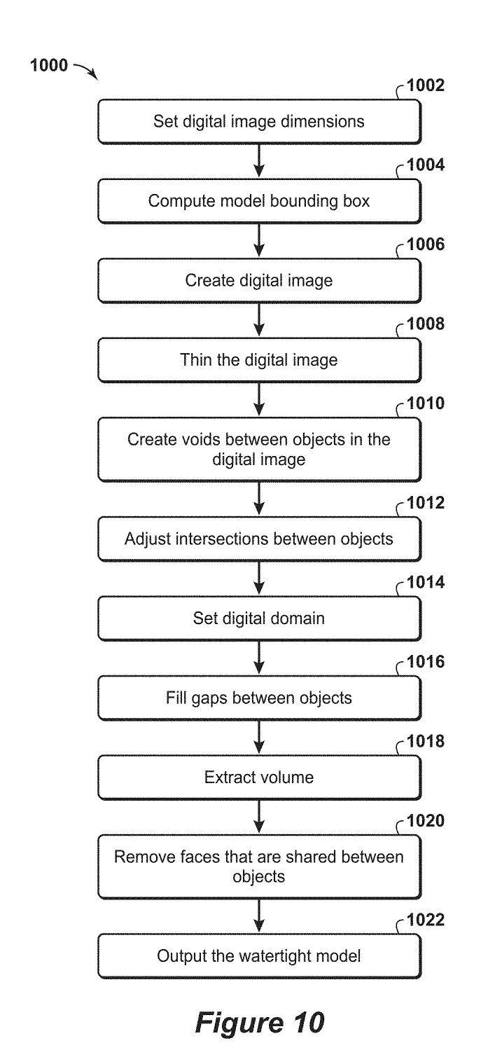

In addition to the creation of the watertight framework, mesh repair may also be performed on a subsurface model (e.g., reservoir model, geological model, and/or watertight model) to further enhance the process. Algorithms for mesh repairing are useful for many geometry processing application. While conventional geometry processing approaches have a variety of techniques to repair meshes, the conventional approaches are not tailored to manage non-manifold meshes (e.g., meshes with T-junctions). Hence, subsurface models with many faults and horizons are not properly addressed by the conventional approaches. The present techniques provide a method, which is described further in FIGS. 6 to 9 for mesh repair that is directed to handling subsurface models and the hierarchical smoothing in FIG. 10.

By way of example, a method of repairing a mesh in accordance with an embodiment of the present techniques is described. Given a set of faults and/or horizons, the first step in the method is to merge the set of faults and/or horizons into a single model, or volumetric representation. Then, the model may be subjected to a series of mesh repair operations, such as local re-meshing, edge flipping and collapsing. In each mesh repair operation, it should be verified that the operation (e.g., local re-meshing, edge flipping or collapsing) does not introduce undesirable topological change. For example, if the model includes a triangular mesh, the mesh repair operations may be utilized to remove small angles (e.g., angles within a mesh that are below a certain threshold) and replace the mesh at those locations with large angles, which may preferably be about 60 degrees. Accordingly, the method should include one or more checks, such as the link condition, and also verify if the gird is at the intersection between horizons and faults.

FIG. 6 is an exemplary flow chart for repairing a mesh in accordance with an embodiment of the present techniques. In this diagram 600, a method of providing mesh repair to eliminate non-manifold edges and vertices and other problems with the mesh. This may be an exemplary method utilized in creating a watertight model in block 106, utilized in creating a geologic model in block 108 and/or utilized in creating a reservoir model in block 110 of FIG. 1. In particular, the present techniques involves water-tightening, mesh repair, and smoothing. The method may include obtaining a model having objects, as shown in blocks 602 to 606, applying one or more mesh repair operations (e.g., local re-meshing, edge flipping and/or collapsing), as shown in blocks 608 to 616, and outputting the updated model, as shown in block 618.

The process begins by obtaining objects for a subsurface region, as shown in blocks 602 to 606. In block 602, objects for a subsurface region are obtained. The objects may include one or more horizons, faults, and model boundaries, and any combination thereof. The obtaining of objects may include accessing one or more objects from a database, updating or modifying objects from subsurface measurements and/or creating objects based on the subsurface measurements. Then, a model for the subsurface region is obtained, as shown in block 604. The obtaining the model may include creating the model and/or accessing the model from memory. At block 606, the objects are inserted into the model. The insertion of the object may include inputting specified surfaces, an area of interest, and relationships between surfaces and then forming a first framework that may or may not be watertight. In a preferred embodiment, the framework is formed with the methods shown in FIGS. 2 to 5. In another embodiment, a framework is generated by another means as block 604 and inputted at block 606.

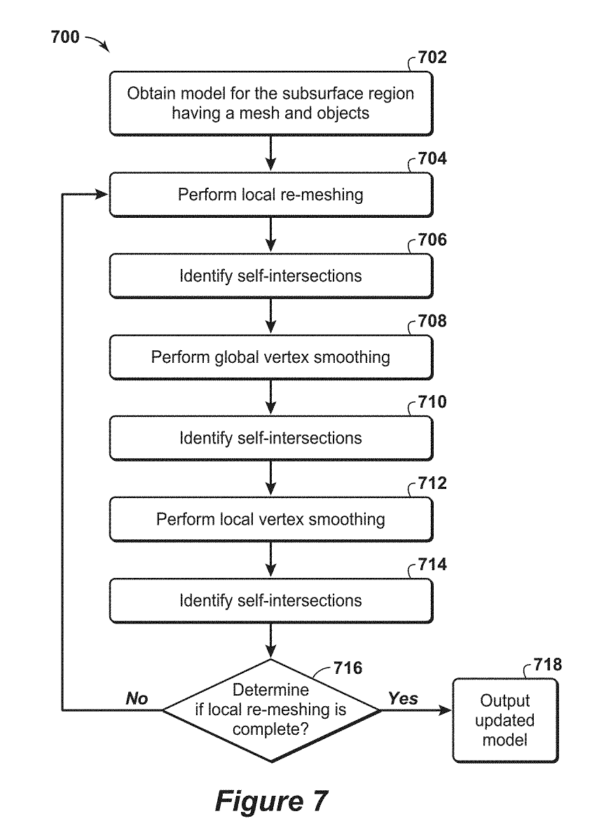

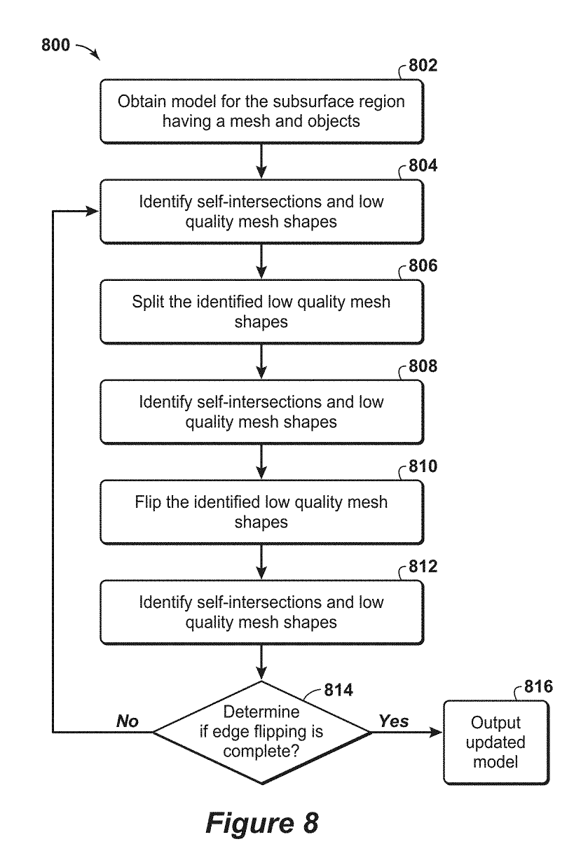

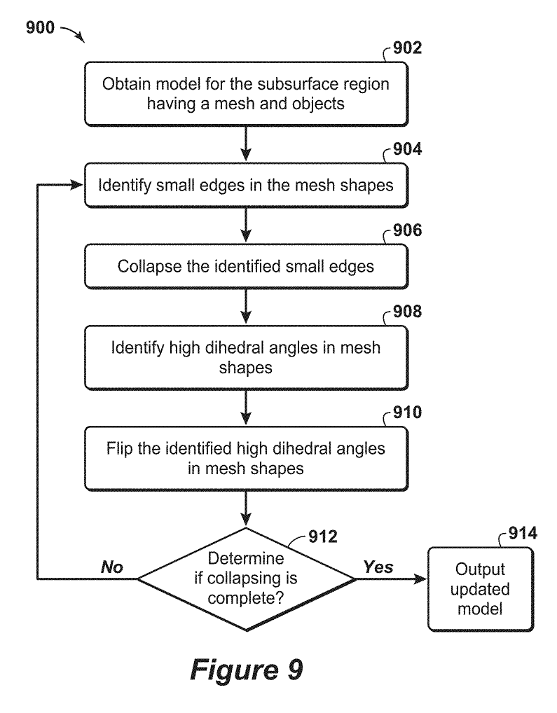

Once the model is created, one or more mesh repair operations (e.g., local re-meshing, edge flipping and/or collapsing) may be applied to the mesh to repair various problematic mesh locations, as shown in blocks 608 to 616. At block 608, areas of the mesh that need repair are identified. The identification of areas for mesh repair may include conversion of the mesh to tetrahedral grid, pairwise check for triangle intersection, or quality measures such as dihedral angles or triangles with two edges on the same intersection. Then, a local re-meshing operation may be applied to one or more of the identified areas in block 610. The local re-meshing operation may include may include deleting interior vertices, relocating interior vertices, and/or creating interior vertices as well as flipping interior triangles, splitting interior triangles, and/or merging interior triangles. The local re-meshing operation is described further below in FIG. 7. Then, an edge flipping operation may be applied to one or more of the identified areas in block 612. The edge flipping operation may include adjusting the edges between two triangles that share a common edge. The edge flipping operation is described further below in FIG. 8. At block 614, a collapsing operation may be applied to one or more of the identified areas. The collapsing operation may include adjusting two adjacent triangles into a single triangle. The collapsing operation is described further below in FIG. 9. Then, at block 616, a determination is made whether the mesh repair is complete. If the mesh repair is not complete, the process may identify areas of mesh that need repair in block 608. Alternatively, one or more of the mesh repair operations in blocks 610, 612 and 614 may be utilized to perform additional mesh repair. If the mesh repair is complete, the updated model is outputted, as shown in block 618. The outputting of the updated model may include storing the updated model in memory and/or displaying the updated model.

FIG. 7 is another exemplary flow chart for repairing a mesh in accordance with an embodiment of the present techniques. In this diagram 700, a method of performing a local re-meshing operation is described. The local re-meshing, which may be an exemplary method utilized in performing a local re-meshing operation in block 610 of FIG. 6, may be utilized to mesh a piece of surface wholly contained contacts or intersection lines. In a preferred embodiment, a piece of surface is deformed by moving points (e.g., control points) on the surface, which necessitates remeshing to preserve mesh quality and validity without spurious intersections. The method may include obtaining a model having objects, as shown in blocks 702, applying local re-meshing, as shown in blocks 704 and 706, applying global vertex smoothing, as shown in blocks 708 and 710, applying local vertex smoothing, as shown in blocks 712 and 714, and outputting the updated model, as shown in block 718.

The process begins by obtaining a model for the subsurface region having a mesh and objects, as shown in block 702, and applying local re-meshing, as shown in blocks 704 and 706. At block 702, a model for the subsurface region having a mesh and objects is obtained. The obtaining of the model may include accessing the model from a database, updating or modifying an existing model and/or creating a new model based on the subsurface measurements. Then, a local re-meshing may be performed, as shown in block 704. The local re-meshing may include deleting interior vertices, relocating interior vertices, and/or creating interior vertices as well as flipping interior triangles, splitting interior triangles, and/or merging interior triangles. At block 706, the self-intersections are identified. The identification of self-intersections may include selecting a triangle and testing a plurality of the remaining triangles for intersection. In another embodiment, the triangles are used as constraints during the generation of a tetrahedral mesh which fails when triangles intersect.

Once the local re-meshing is complete, global vertex smoothing is applied, as shown in blocks 708 and 710. At block 708, a global vertex smoothing may be performed. The global vertex smoothing may include plain smoothing or hierarchical smoothing where specified vertices in the interior of pieces surfaces and on surface intersections remain fixed. At block 710, the self-intersections are identified. The identification of self-intersections may include selecting a triangle and testing a plurality of the remaining triangles for intersection. In another embodiment, the triangles are used as constraints during the generation of a tetrahedral mesh which fails when triangles intersect.

Upon completion of the global vertex smoothing, local vertex smoothing is applied, as shown in blocks 712 and 714. At block 712, a local vertex smoothing may be performed. The local vertex smoothing may include a single surface, for example. At block 714, the self-intersections are identified. The identification of self-intersections may include selecting a triangle and testing a plurality of the remaining triangles for intersection. In another embodiment, the triangles are used as constraints during the generation of a tetrahedral mesh which fails when triangles intersect.

Once the local vertex smoothing is complete, a determination is made whether the local re-meshing is complete, as shown in block 716. If the local re-meshing is not complete, the process may identify additional areas of mesh that are to be subjected to the local re-meshing and return to block 704. If a first piece of surface is moved not only in its interior but also on its boundary, then at least one other piece of another surface may need to be re-meshed because contacts or surface intersections were deformed. In some embodiment, these deformations are small and no further action is required. In a preferred embodiment, other surfaces are analyzed for mesh quality, intersection, and validity. If the local re-meshing is complete, the updated model is outputted, as shown in block 718. The outputting of the updated model may include storing the updated model in memory and/or displaying the updated model. The updated model may be then be subjected to other mesh repair operations.

FIG. 8 is yet another exemplary flow chart for repairing a mesh in accordance with an embodiment of the present techniques. In this diagram 800, a method of performing an edge flipping operation is described. The edge flipping, which may be an exemplary method utilized in performing an edge flipping operation in block 612 of FIG. 6, may be utilized to improve mesh quality by flipping a pair of triangles with at least one small dihedral angle, to remove a spurious intersection by flipping a pair of triangles that includes a cap triangle or to remove a spurious intersection by splitting a cap triangle. The method may include obtaining a model having objects, as shown in blocks 802, identifying low quality mesh shapes and splitting the identified low quality mesh shapes, as shown in blocks 804 and 806, identifying self-intersections and low quality mesh shapes and flipping the low quality mesh shapes, as shown in blocks 808 and 810, and identifying self-intersections and low quality mesh shapes and determining if the edge flipping operation is compete, as shown in blocks 812 to 816.

The process begins by obtaining a model for the subsurface region having a mesh and objects, as shown in block 802, and identifying low quality mesh shapes and splitting the identified low quality mesh shapes, as shown in blocks 804 and 806. At block 802, a model for the subsurface region having a mesh and objects is obtained. The obtaining of the model may include accessing the model from a database, updating or modifying an existing model and/or creating a new model based on the subsurface measurements. Then, self-intersections and low quality mesh shapes are identified, as shown in block 804. The identification of the self-intersections and low quality mesh shapes may include selecting a triangle and testing a plurality of the remaining triangles for intersection and/or may include associating the triangle with a flag and/or indicator. In another embodiment, the triangles are used as constraints during the generation of a tetrahedral mesh which fails when triangles intersect, as well as computing the triangle angles and comparing them against a specified threshold to identify triangles with small dihedral angles. At block 806, the identified self-intersections and low quality mesh shapes are split. The splitting of the identified self-intersections and low quality mesh shapes may include determining a flag or indication for the respective triangles. Further, the splitting of the identified self-intersections and low quality mesh shapes may not be performed if the splitting changes the topology of the mesh such as creating a whole, a spurious intersection or a new contact with a previously not-contacted surface.

Once the splitting of the low quality mesh shapes is complete, the method performs identifying self-intersections and low quality mesh shapes and flipping the low quality mesh shapes, as shown in blocks 808 and 810. At block 808, self-intersections and low quality mesh shapes are identified. The identification of the self-intersections and low quality mesh shapes may include selecting a triangle and testing a plurality of the remaining triangles for intersection. In another embodiment, the triangles are used as constraints during the generation of a tetrahedral mesh which fail when triangles intersect, as well as computing the triangle angles and comparing them against a specified threshold to identify triangles with small dihedral angles. At block 810, the identified self-intersections and low quality mesh shapes are flipped. The flipping of the identified self-intersections and low quality mesh shapes may include selecting pairs of triangles where a first triangle of the pair either exhibits a self-intersection, an intersection with another surface, and/or at least one small dihedral angle. Also, the flipping of the identified self-intersections and low quality mesh shapes may not be performed if the flipping changes the topology of the mesh where a hole is created, a hole is filled, or a spurious contact is created.

Upon completion of the flipping of the identified self-intersections and low quality mesh shapes, the identification of self-intersections and low quality mesh shapes and determination whether the edge flipping operation is compete is performed, as shown in blocks 812 to 816. The self-intersections and low quality mesh shapes are identified, as shown in block 812. The identification of the self-intersections and low quality mesh shapes may include selecting a first triangle and comparing it against a plurality of remaining triangles. In another embodiment, the triangles are used as constraints for filling the model with tetrahedral which fails when triangles have spurious intersections. Then, a determination is made whether the edge flipping is complete, as shown in block 814. If the edge flipping is not complete, the process may identify additional areas of mesh that are to be subjected to the edge flipping and return to block 804. In some embodiments, a determination whether edge flipping is complete may be based on a mesh quality measure, such as minimal edge length or minimal dihedral angle. In another embodiment, a determination may be made based on the detection of at least one spurious intersection by analyzing a plurality of triangle pairs for intersection or by attempting to fill the mesh with tetrahedra constrained by a plurality of mesh triangles. If the edge flipping is complete, the updated model is outputted, as shown in block 816. The outputting of the updated model may include storing the updated model in memory and/or displaying the updated model. The updated model may be then be subjected to other mesh repair operations.

FIG. 9 is still another exemplary flow chart 900 for repairing and improving a mesh in accordance with an embodiment of the present techniques. In this diagram 900, a method of performing a collapsing operation is described. The collapsing, which may be an exemplary method utilized in performing a collapsing operation in block 614 of FIG. 6, may be utilized to improve mesh quality by combination of neighboring mesh vertices which removes mesh elements with short edges and/or small areas. The method may include obtaining a model having objects, as shown in blocks 902, identifying small edges and collapsing the small edges, as shown in blocks 904 and 906, identifying high dihedral angles in the mesh shapes and flipping the identified high dihedral angles in the mesh shapes, as shown in blocks 908 and 910, and determining if the collapsing operation is compete, as shown in block 912 and 914.

The process begins by obtaining a model for the subsurface region having a mesh and objects, as shown in block 902, and identifying small edges and collapsing the small edges, as shown in blocks 904 and 906. At block 902, a model for the subsurface region having a mesh and objects is obtained. The obtaining of the model may include accessing the model from a database, updating or modifying an existing model and/or creating a new model based on the subsurface measurements. Then, small edges in the mesh shapes are identified, as shown in block 904. The identification of the small edges in the mesh shapes may include computing the length of a plurality of edges for a plurality of mesh elements and comparing these lengths against a specified threshold. In another embodiment, the area of a specified mesh element may serve as a proxy for edge length. In yet another embodiment, one of the ratio between mesh element perimeter and mesh element or the ratio between minimal edge length and mesh perimeter is used to identify collapse candidates. At block 906, the identified small edges are collapsed. The collapsing of the identified small edges may include selecting the mesh elements that contain either one of the two vertices forming the short edge, replacing these two vertices with one representative vertex, and re-meshing the mesh elements using the representative vertex instead of the two original ones. The representative vertex may be obtained by selection of either of the two vertices or by computation, for example, by forming the average of said two vertices. Further, the collapsing of the small edges may not be performed if the collapsing changes the topology of the mesh by creation of spurious mesh intersection, by creation of new contacts, or formation of a hole.

Once the collapsing of the small edges is complete, the method performs identifying high dihedral angles in the mesh shapes and flipping the identified high dihedral angles in the mesh shapes, as shown in blocks 908 and 910. At block 908, high dihedral angles in the mesh shapes are identified. The identification of the high dihedral angles in the mesh shapes may include computing a plurality of interior angles for a plurality of mesh shapes or by detection of mesh shapes with aspect ratios exceeding a specified threshold. At block 910, the identified high dihedral angles in the mesh shapes are flipped. The flipping of the identified high dihedral angles in the mesh shapes may include select a mesh shape with dihedral angles and one of its neighbors and re-meshing said two shapes. Also, the flipping of the identified high dihedral angles in the mesh shapes may not be performed if the flipping changes the topology of the mesh by creation of a hole, new contact, and/or spurious intersection.

Upon completion of the flipping of the identified high dihedral angles in the mesh shapes, the determination whether the collapsing operation is compete is performed, as shown in blocks 912 and 914. The determination is made whether the collapsing is complete, as shown in block 912. In one embodiment, determination is made by performing blocks 904 to 910 to a specified plurality of surfaces or elements thereof. In another embodiment, a quality measure is formed for a specified plurality of surfaces or elements thereof and the workflow is iterated until a specified quality is reached or until a specified number of iteration is reached. If the collapsing is not complete, the process may identify additional areas of mesh that are to be subjected to the collapsing operations and return to block 904. If the collapsing is complete, the updated model is outputted, as shown in block 914. The outputting of the updated model may include storing the updated model in memory and/or displaying the updated model. The updated model may then be subjected to other mesh repair operations.

FIG. 10 is an exemplary flow chart 1000 for building a watertight model in accordance with an embodiment of the present techniques. In this diagram 1000, a method of creating a watertight model is described. The method may include building a volumetric representation (e.g., a digital image), as shown in blocks 1002 to 1008, creating a watertight model from the objects within the volumetric representation, as shown in blocks 1010 to 1022.

The process begins by building a volumetric representation, as shown in blocks 1002 to 1008. In block 1002, digital image dimensions are set. The setting of the digital image dimensions may include inputting the number of blocks along mutually exclusive directions or inputting the block dimensions along mutually exclusive directions. At block 1004, the model bounding box is computed. The computing the bounding box may include inputting the bounding box or computation from the inputted surfaces. The computing the bounding box may include obtaining input surfaces or objects, which may involve accessing the surfaces from memory and/or determining the list of surfaces. At block 1006, a digital image is created. The creation of the digital image may include labeling blocks of the digital representation with surfaces that pass through the blocks. The input to the creation of the digital image may include the digital image dimensions, the input surfaces, and the model bounding box, while the output may be the digital image associated with the subsurface region. At block 1008, the created digital image is thinned. The thinning of the digital image may include retracting the digital image, decomposing the block into its faces reassigning the surface labels from the block to its faces. In a preferred embodiment, this reassignment is performed in such a way that the surface representation using the block faces is contiguous if the inputted surface is contiguous.

Once the digital image is created, creating a watertight model from the objects, as shown in blocks 1010 to 1022. At block 1010, voids are created between objects in the digital image. The creation of voids may include removing a horizon label from a block if said block is within a specified distance from any fault or another block labeled by a fault. In one embodiment, horizon labels are removed from blocks that are also labeled by a fault. At block 1012, the intersections between objects are adjusted. The adjustment of the intersections may include moving the objects spatially by transferring their label from one block to another one or by transferring their label from one block face to either another face of the same block or to a face of another block. Then, the digital domain is set, as shown in block 1014. The setting of the digital domain may include limiting the digital image to the volume of interest, which may be provided by polylines, control points, depth values, or specified surfaces. At block 1016, the gaps between objects are filled. The filling of gaps may include extrapolation using an object priority function (e.g., using a signed-distance field or using a priority field). In a preferred embodiment, one or more object priority functions are specified to aid the extrapolation of horizons and faults within the digital domain. In a preferred embodiment, this digital domain is by block (for example, by voxelization). In another preferred embodiment, this digital domain is by cubic complexes (for example, by the faces of blocks). Once the gaps are filled, the volume may be extracted, as shown in block 1018. The extraction of the volume may include representing labeled blocks or their faces by blocks, faces, or secondary meshing of the faces. The output from the volume extraction is the digital image and the volumes. Then, faces that are shared between objects are removed, as shown in block 1020. The same face may originally be labelled with multiple surfaces. But for a watertight model, each face can only be assigned to one surface. In a watertight model, surface intersections occur on face edges. If a face is labelled by multiple surfaces, then the surface hierarchy may be used to remove all but one label. Then, the watertight model is outputted, as shown in block 1022. The outputting of the watertight model may include storing the watertight model in memory and/or displaying the watertight model. The watertight model, which is the updated digital image, may be subjected to other mesh repair operations.

Persons skilled in the technical field will readily recognize that in practical applications of the disclosed methodology, it is partially performed on a computer, typically a suitably programmed digital computer. Further, some portions of the detailed descriptions which follow are presented in terms of procedures, steps, logic blocks, processing and other symbolic representations of operations on data bits within a computer memory. These descriptions and representations are the means used by those skilled in the data processing arts to most effectively convey the substance of their work to others skilled in the art. In the present application, a procedure, step, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present application, discussions utilizing the terms such as “processing” or “computing”, “calculating”, “comparing”, “determining”, “displaying”, “copying,” “producing,” “storing,” “adding,” “applying,” “executing,” “maintaining,” “updating,” “creating,” “constructing” “generating” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the present techniques also relate to an apparatus for performing the operations herein. This apparatus may be specially constructed for the required purposes, or it may comprise a general-purpose computer selectively activated or reconfigured by a computer program stored in the computer (e.g., one or more sets of instructions). Such a computer program may be stored in a computer readable medium. A computer-readable medium includes any mechanism for storing or transmitting information in a form readable by a machine (e.g., a computer). For example, but not limited to, a computer-readable (e.g., machine-readable) medium includes a machine (e.g., a computer) readable storage medium (e.g., read only memory (“ROM”), random access memory (“RAM”), magnetic disk storage media, optical storage media, flash memory devices, etc.), and a machine (e.g., computer) readable transmission medium (electrical, optical, acoustical or other form of propagated signals (e.g., carrier waves, infrared signals, digital signals, etc.)).

Furthermore, as will be apparent to one of ordinary skill in the relevant art, the modules, features, attributes, methodologies, and other aspects of the invention can be implemented as software, hardware, firmware or any combination of the three. Of course, wherever a component of the present invention is implemented as software, the component can be implemented as a standalone program, as part of a larger program, as a plurality of separate programs, as a statically or dynamically linked library, as a kernel loadable module, as a device driver, and/or in every and any other way known now or in the future to those of skill in the art of computer programming. Additionally, the present invention is in no way limited to implementation in any specific operating system or environment.

Further, one or more embodiments may include methods that are performed by executing one or more sets of instructions to perform modeling enhancements in various stages. For example, the method may include executing one or more sets of instructions to perform comparisons between thresholds current statuses or indications along with transmitting data between modules, components and/or sensors.

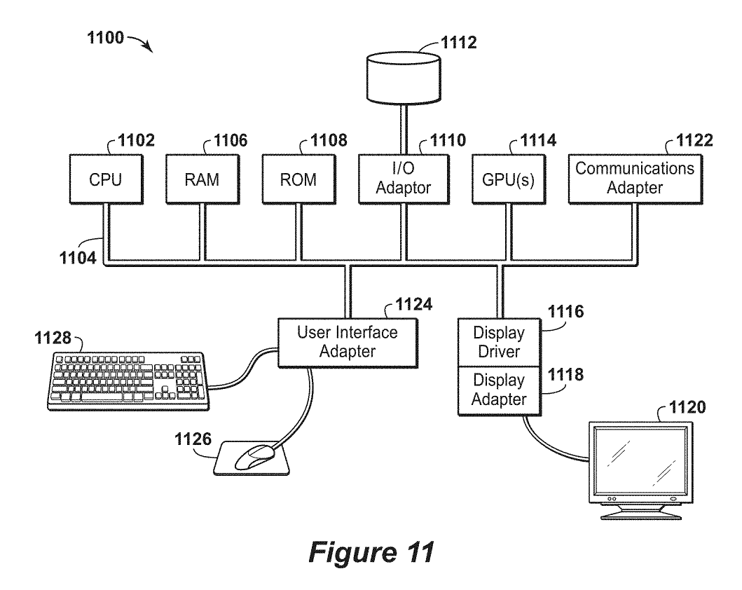

As an example, FIG. 11 is a block diagram of a computer system 1100 that may be used to perform any of the methods disclosed herein. A central processing unit (CPU) 1102 is coupled to system bus 1104. The CPU 1102 may be any general-purpose CPU, although other types of architectures of CPU 1102 (or other components of exemplary system 1100) may be used as long as CPU 1102 (and other components of system 1100) supports the inventive operations as described herein. The CPU 1102 may execute the various logical instructions according to disclosed aspects and methodologies. For example, the CPU 1102 may execute machine-level instructions for performing processing according to aspects and methodologies disclosed herein.

The computer system 1100 may also include computer components such as a random access memory (RAM) 1106, which may be SRAM, DRAM, SDRAM, or the like. The computer system 1100 may also include read-only memory (ROM) 1108, which may be PROM, EPROM, EEPROM, or the like. RAM 1106 and ROM 1108 hold user and system data and programs, as is known in the art. The computer system 1100 may also include an input/output (I/O) adapter 1110, a communications adapter 1122, a user interface adapter 1124, and a display adapter 1118. The I/O adapter 1110, the user interface adapter 1124, and/or communications adapter 1122 may, in certain aspects and techniques, enable a user to interact with computer system 1100 to input information.

The I/O adapter 1110 preferably connects a storage device(s) 1112, such as one or more of hard drive, compact disc (CD) drive, floppy disk drive, tape drive, etc. to computer system 1100. The storage device(s) may be used when RAM 1106 is insufficient for the memory requirements associated with storing data for operations of embodiments of the present techniques. The data storage of the computer system 1100 may be used for storing information and/or other data used or generated as disclosed herein. The communications adapter 1122 may couple the computer system 1100 to a network (not shown), which may enable information to be input to and/or output from system 1100 via the network (for example, a wide-area network, a local-area network, a wireless network, any combination of the foregoing). User interface adapter 1124 couples user input devices, such as a keyboard 1128, a pointing device 1126, and the like, to computer system 1100. The display adapter 1118 is driven by the CPU 1102 to control, through a display driver 1116, the display on a display device 1120. Information and/or representations of one or more 2D canvases and one or more 3D windows may be displayed, according to disclosed aspects and methodologies.

The architecture of system 1100 may be varied as desired. For example, any suitable processor-based device may be used, including without limitation personal computers, laptop computers, computer workstations, and multi-processor servers. Moreover, embodiments may be implemented on application specific integrated circuits (ASICs) or very large scale integrated (VLSI) circuits. In fact, persons of ordinary skill in the art may use any number of suitable structures capable of executing logical operations according to the embodiments.

In one or more embodiments, the method may be implemented in machine-readable logic, such that a set of instructions or code that, when executed, performs the instructions or operations from memory. The computer system may include a processor; an input device in communication with the processor and configured to receive input data associated with a subsurface region; and memory in communication with the processor, the memory having a set of instructions. The set of instructions, when executed, are configured to: obtain a volumetric representation associated with a subsurface region; obtain a plurality of objects associated with the subsurface region, wherein the plurality of objects comprise one or more of faults, horizons, and any combination thereof; insert the plurality of object into the volumetric representation, wherein the volumetric representation comprises a plurality of blocks; compute a value for each of the plurality of blocks based on an object priority function (e.g., signed distance or priority field); compute constraints; remove one or more blocks of the plurality of blocks based on the constraints and the object priority function to create a watertight model; and output the watertight model.

Further, the set of instructions may also be configured to: compute the value based on a priority field; compute the value based on a signed distance; compute one or more intersections of two or more of the plurality of object, and apply a morphological operator to the one or more intersections; create a geologic model from the watertight model by assigning properties to the watertight model; create a reservoir model from the watertight model by assigning properties associated with fluid flow to the watertight model; simulate fluid flow within the reservoir model to create simulation results; to visualize the simulation results for hydrocarbon operations; identify blocks in the mesh of the watertight model that need repair, apply to the identified blocks one or more of a local re-meshing operation, an edge-flipping operation, a collapsing operation and any combination thereof, and output the updated watertight model; determine whether the object priority function value is a local minimum relative to specified adjacent blocks; determine a removed or missing neighboring block for each of the plurality of blocks; determine whether the block has a flag or indication; determine whether each of the plurality of blocks is enclosed by adjacent blocks, and flag the block if it is enclosed by adjacent blocks; and/or determine whether the object priority function value is within a specified range.

For example, the memory may store an instance of the digital image and a list of model objects associated with a subsurface region. The model objects may represent a volume part (e.g., a compartment) or one of the input surfaces, such as faults, horizons and boundary surfaces. The set of instructions may be configured to create watertight model from the digital image, which includes objects, such as surfaces. The set of instructions may be used to generate a triangle mesh, if necessary, from the digital image.

As another example, the memory may store an instance of the volumetric representation associated with a subsurface region. The set of instructions configured to adjust the objects within the volumetric representation for pinch-outs. In particular, the set of instructions may be configured to split the conversion of narrow layers in three sets of instructions: (1) detection of collapsed parts of layers, (2) removal of volume parts and (3) splitting of surface patches for consistent representation of pinch-outs through contacts. The detection of collapsed sets of instructions may be utilized before volume detection. The collapsed results may be stored in memory, and read after volume detection. Once read, the volume detection post-processing may be configured to verify that the collapsed results are properly represented. An additional set of instructions may be configured to perform surface patching.

It should be understood that the preceding is merely a detailed description of specific embodiments of the invention and that numerous changes, modifications, and alternatives to the disclosed embodiments can be made in accordance with the disclosure here without departing from the scope of the invention. The preceding description, therefore, is not meant to limit the scope of the invention. Rather, the scope of the invention is to be determined only by the appended claims and their equivalents. It is also contemplated that structures and features embodied in the present examples can be altered, rearranged, substituted, deleted, duplicated, combined, or added to each other.

The foregoing description is directed to particular embodiments of the present invention for the purpose of illustrating it. It will be apparent, however, to one skilled in the art, that many modifications and variations to the embodiments described herein are possible. All such modifications and variations are intended to be within the scope of the present invention, as defined by the appended claims.

1. A method for generating a subsurface model having one or more object for a subsurface region comprising:
obtaining a volumetric representation associated with a subsurface region;
obtaining a plurality of objects associated with the subsurface region, wherein the plurality of objects comprise one or more of faults, horizons, and any combination thereof;
inserting the plurality of object into the volumetric representation, wherein the volumetric representation comprises a plurality of blocks;
computing a value for each of the plurality of blocks based on an object priority function;
computing constraints;
removing one or more blocks of the plurality of blocks based on the constraints and the object priority function to create the watertight model; and
outputting the watertight model.

2. The method of claim 1, wherein computing the value for each of the plurality of blocks comprises computing the value based on a priority field.

3. The method of claim 1, wherein computing the value for each of the plurality of blocks comprises computing the value based on a signed distance.

4. The method of claim 1, further comprising:
computing one or more intersections of two or more of the plurality of object; and
applying a morphological operator to the one or more intersections.

5. The method of claim 1, wherein the watertight model comprises a watertight mesh that comprises a plurality of model blocks.

6. The method of claim 5, further comprising creating a geologic model from the watertight model by assigning properties to one or more of the plurality of model blocks in the watertight model.

7. The method of claim 5, further comprising creating a reservoir model from the watertight model by assigning properties associated with fluid flow to one or more of the plurality of blocks in the watertight model.

8. The method of claim 7, further comprising simulating fluid flow within the reservoir model to create simulation results.

9. The method of claim 8, further comprising managing hydrocarbon production based on the simulation results.

10. The method of claim 1, further comprising:
identifying blocks in the mesh of the watertight model that need repair;
applying to the identified blocks one or more of a local re-meshing operation, an edge-flipping operation, a collapsing operation and any combination thereof;
outputting the updated watertight model.

11. The method of claim 1, wherein computing the constraints comprises determining whether the object priority function value is a local minimum relative to specified adjacent blocks.

12. The method of claim 1, wherein computing the constraints comprises determining a removed or missing neighboring block for each of the plurality of blocks.

13. The method of claim 1, wherein computing the constraints comprises determining whether the block has a flag or indication.

14. The method of claim 1, wherein computing the constraints comprises determining whether each of the plurality of blocks is enclosed by adjacent blocks; and flagging the block if it is enclosed by adjacent blocks.

15. The method of claim 1, wherein computing the constraints comprises determining whether the object priority function value is within a specified range.

16. A system for generating a subsurface model having one or more objects associated with a subsurface region, comprising:
a processor;
an input device in communication with the processor and configured to receive input data associated with a subsurface region;
memory in communication with the processor, the memory having a set of instructions, wherein the set of instructions, when executed, are configured to:
obtain a volumetric representation associated with a subsurface region;
obtain a plurality of objects associated with the subsurface region, wherein the plurality of objects comprise one or more of faults, horizons, and any combination thereof;
insert the plurality of object into the volumetric representation, wherein the volumetric representation comprises a plurality of blocks;
compute a value for each of the plurality of blocks based on an object priority function;
compute constraints;
remove one or more blocks of the plurality of blocks based on the constraints and the object priority function to create a watertight model; and
output the watertight model.

17. The system of claim 16, wherein the set of instructions, when executed, are further configured to compute the value based on a priority field.

18. The system of claim 16, wherein the set of instructions, when executed, are further configured to compute the value based on a signed distance.

19. The system of claim 16, wherein the set of instructions, when executed, are further configured to:
compute one or more intersections of two or more of the plurality of object; and
apply a morphological operator to the one or more intersections.

20. The system of claim 16, wherein the set of instructions, when executed, are further configured to create a geologic model from the watertight model by assigning properties to the watertight model.

21. The system of claim 16, wherein the set of instructions, when executed, are further configured to create a reservoir model from the watertight model by assigning properties associated with fluid flow to the watertight model.

22. The system of claim 21, wherein the set of instructions, when executed, are further configured to simulate fluid flow within the reservoir model to create simulation results.

23. The system of claim 22, wherein the set of instructions, when executed, are further configured to visualize the simulation results for hydrocarbon operations.

24. The system of claim 16, wherein the set of instructions, when executed, are further configured to:
identify blocks in the mesh of the watertight model that need repair;
apply to the identified blocks one or more of a local re-meshing operation, an edge-flipping operation, a collapsing operation and any combination thereof;
output the updated watertight model.

25. The system of claim 16, wherein the set of instructions, when executed, are further configured to determine whether the object priority function value is a local minimum relative to specified adjacent blocks.

26. The system of claim 16, wherein the set of instructions, when executed, are further configured to determine a removed or missing neighboring block for each of the plurality of blocks.

27. The system of claim 16, wherein the set of instructions, when executed, are further configured to determine whether the block has a flag or indication.

28. The system of claim 16, wherein the set of instructions, when executed, are further configured to:
determine whether each of the plurality of blocks is enclosed by adjacent blocks; and
flag the block if it is enclosed by adjacent blocks.

29. The system of claim 16, wherein the set of instructions, when executed, are further configured to determine whether the object priority function value is within a specified range.
